(19) United States
(12) Patent Application Publication
(10) Pub. No.: US 2025/0249442 A1
(43) Pub. Date: Aug. 7, 2025

(54) REBALANCING REACTOR RECOVERY

(71) Applicant: ESS Tech, Inc., Wilsonville, OR (US)

(72) Inventors: Sean Kissick, Portland, OR (US); Jackson Miller, Portland, OR (US); Yang Song, Durham, NC (US)

(21) Appl. No.: 19/043,251

(22) Filed: Jan. 31, 2025

Related U.S. Application Data
(60) Provisional application No. 63/548,767, filed on Feb. 1, 2024.

(51) Int. Cl. B01J 37/00; B01J 37/16

(52) U.S. Cl. CPC B01J 37/0072; B01J 37/16

(57) ABSTRACT

Systems and methods are provided for recovering performance of rebalancing systems of a redox flow battery system. The method includes contacting a catalyst of the rebalancing system with a citrate solution. The citrate solution disperses a diffusion double layer from a surface of the catalyst.

### CROSS-REFERENCE TO RELATED APPLICATIONS

The present applicant claims priority to U.S. Provisional Patent No. 63/548,767 entitled “REBALANCING REACTOR RECOVERY”, filed Feb. 1, 2024. The entire contents of the above identified application(s) are hereby incorporated by reference for all purposes.

### FIELD

The present description relates generally to methods and systems for recovering performance of a rebalancing system after prolonged usage.

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. An all-iron hybrid redox flow battery is particularly attractive due to incorporation of low-cost, earth-abundant materials. In general, iron redox flow batteries (IFBs) rely on iron, salt, and water for electrolyte, thus including simple, earth-abundant, and inexpensive materials, and eliminating incorporation of harsh chemicals and reducing an environmental footprint thereof.

The IFB may include a positive (redox) electrode where a redox reaction occurs and a negative (plating) electrode where ferrous iron (Fe²⁺) in the electrolyte may be reduced and plated. Various side reactions may compete with the Fe²⁺ reduction, including proton reduction, iron corrosion, and iron plating oxidation:

H⁺+e⁻⇄½H₂ (proton reduction) (1)

Fe⁰+2H⁺⇄Fe²⁺+H₂ (iron corrosion) (2)

2Fe³⁺+Fe⁰⇄3Fe²⁺ (iron plating oxidation) (3)

As most side reactions occur at the plating electrode, IFB cycling capabilities may be limited by available iron plating on the plating electrode. Exemplary attempts to ameliorate iron plating loss have focused on catalytic electrolyte rebalancing to address hydrogen (H₂) gas generation from equations (1) and (2) and electrolyte charge imbalances (e.g., excess Fe³⁺) from equation (3) by ion crossover via equation (4):

Fe³⁺+½H₂⇄Fe²⁺+H⁺ (electrolyte rebalancing) (4)

In some examples, the electrolyte rebalancing of equation (4) may be realized via a rebalancing system configured to react hydrogen gas with electrolyte. In some examples, the rebalancing system may be a rebalancing cell configured as a fuel cell, where the H₂ gas and the electrolyte may be introduced to the rebalancing cell separately and come into contact with one another at catalyst surfaces while a direct current (DC) is applied across positive and negative electrode pairs. In other examples, the rebalancing system may be a rebalancing reactor and may be configured as a trickle bed or a jelly roll reactor, either of which may similarly receive electrolyte suffused with H₂ gas as a single input and promote contact between the H₂ gas and the electrolyte at catalyst surfaces.

In some examples, to achieve relatively high rebalancing performance with relatively low amounts of H₂ gas, a rebalancing cell may include a stack of electrode assemblies, each electrode assembly including positive and negative electrodes in face-sharing contact with one another such that the positive and negative electrodes may be continuously electrically conductive (e.g., at surfaces of the positive and negative electrodes in face-sharing contact). In additional or alternative examples, no electric current may be directed away from the rebalancing cell. In this way, electrolyte rebalancing in the rebalancing cell may be driven via internal electrical shorting of interfacing pairs of the positive and negative electrodes therein. Further, in some examples, the rebalancing cell may be configured to draw each of the liquid electrolyte and H₂ gas (e.g., via forced convection, gravity feeding, capillary action, etc.) therethrough. By managing electrolyte and H₂ gas flows in this way, in combination with the internal electrical shorting, the Fe³⁺ reduction rate of the rebalancing cell may be increased over conventional rebalancing cell setups (e.g., by a factor of 20 or more).

In either a rebalancing cell or rebalancing reactor setup, a catalyst may be included to make the chemical reaction of equation (4) more energetically favorable. Over time, the catalyst surface may adsorb anions from the electrolyte which in turn attracts cations creating a diffusion double layer at the catalyst surface. The diffusion double layer may prevent the desired reactants from reaching the catalyst surface, thus poisoning the catalyst and hindering performance of the rebalancing system. In one example, performance may be recovered by replacing the catalyst. In alternate examples, the diffusion double layer may be remediated and the performance of the rebalancing system recovered by flushing the rebalancing system with hot (e.g., >90° C.) water. In alternate examples, the diffusion double layer may be remediated by application of an electric field to the catalyst layer, which repels the ions forming the diffusion double layer.

The inventors have recognized several drawbacks of the above-mentioned methods for recovering performance of a rebalancing system. Simply replacing degraded catalyst may be prohibitively expensive, especially when the catalyst is a rare metal, such as platinum. Flushing with hot water may be logistically difficult with respect to heating and transporting water at almost boiling temperatures and 90° C. may be above a preferred operating temperature range for some materials of the rebalancing system. Further, in some examples, such as when the rebalancing reactor is configured as an internally shorted rebalancing cell, the unit may be sealed within housing and introducing electrical connections to the catalyst layer may not be possible.

In one example, the issues described may be at least partially addressed by a method for recovering a rebalancing system. The method comprises pretreating the rebalancing system with water, contacting a catalyst of the rebalancing system with a citrate solution, wherein the citrate solution disperses a diffusion double layer from a surface of the catalyst. In this way, performance of the catalyst may be recovered and demand for replacing the expensive material may be avoided. The method and system may be compatible with many different rebalancing systems, including rebalancing reactors and rebalancing cells. Further the process may be conducted using mild temperature solutions which may demand minimal energy input and be compatible with all rebalancing system materials.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including a rebalancing system.

FIG. 2 shows an example of a rebalancing cell.

FIG. 3. shows an exploded view of an electrode assembly of the rebalancing cell.

FIG. 4 shows an example of a rebalancing reactor.

FIG. 5 shows an example of a method for recovering performance of a rebalancing system.

FIG. 6 shows a graph of reduction rate as a function of state of charge for pristine and used rebalancing cell.

FIG. 7 shows a graph of reduction rate normalized by SOC and reduction rate normalized by initial performance for a rebalancing cell recovered by different recovery procedures.

FIG. 8 shows a graph percent reduction rate increase for the rebalancing cell over a previous test for different recovery procedures performed sequentially.

FIG. 9 shows a graph of normalized reduction rate before and after recovery for different rebalancing cells.

FIG. 10 shows a graph of initial, degraded and recovered ferric reduction rates for rebalancing reactors.

FIG. 11 shows a graph of initial, degraded and recovered reduction rates and of platinum concentration for rebalancing reactors.

FIG. 12 shows a graph of ferric reduction rate for degraded rebalancing reactors and rebalancing reactors recovered with 20° C. and 60° C. sodium citrate solutions.

FIG. 13 shows a graph of percent change after recover for subscale and full scale rebalancing reactors.

### DETAILED DESCRIPTION

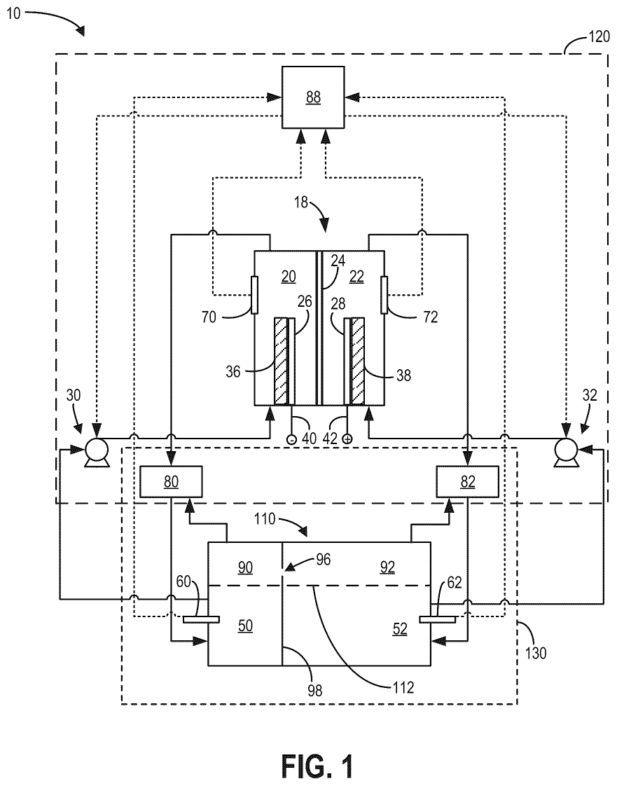

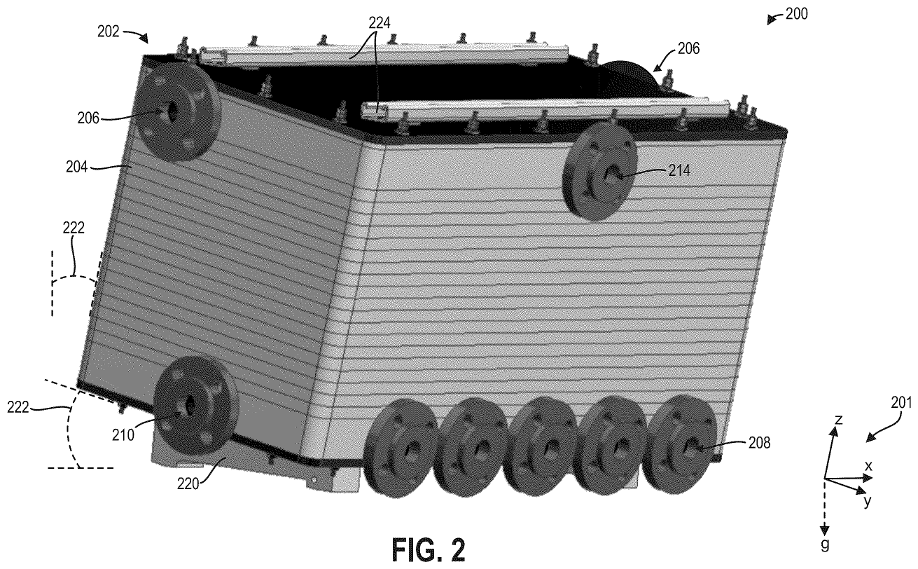

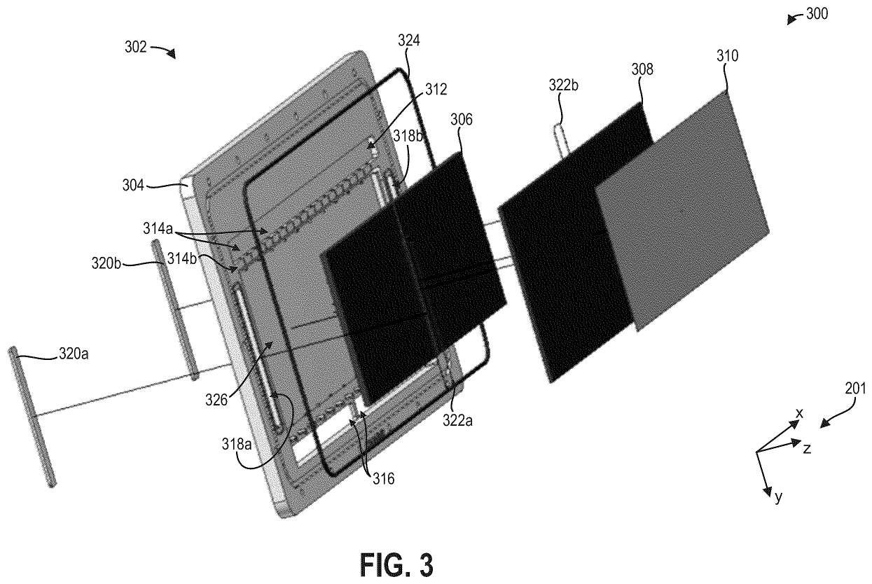

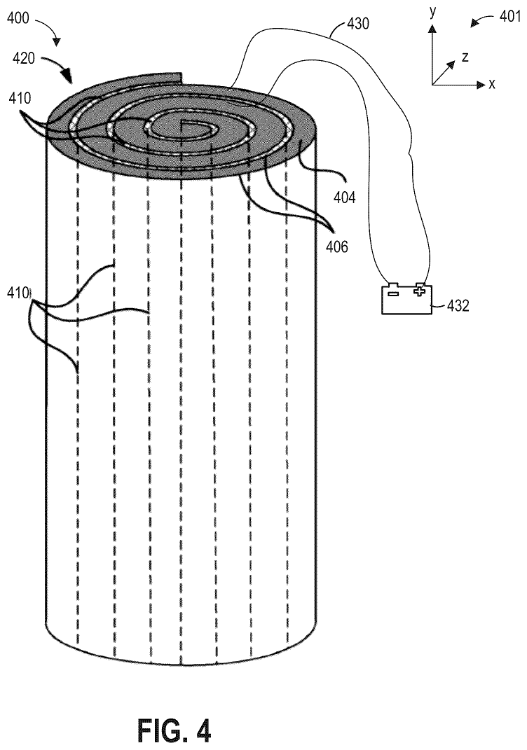

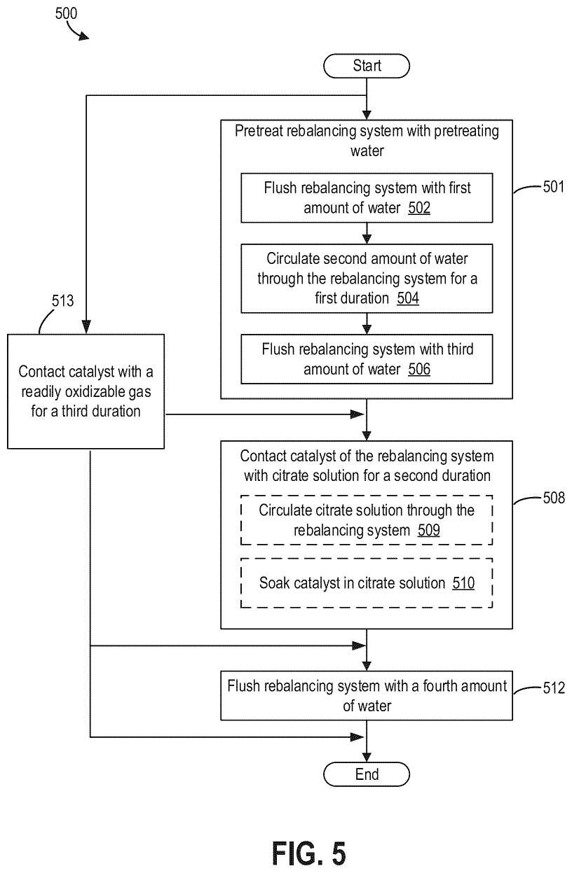

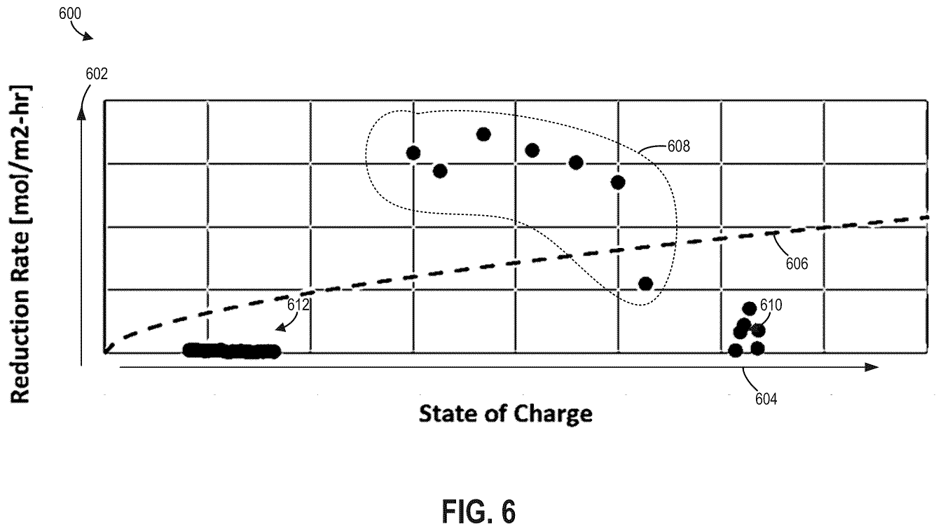

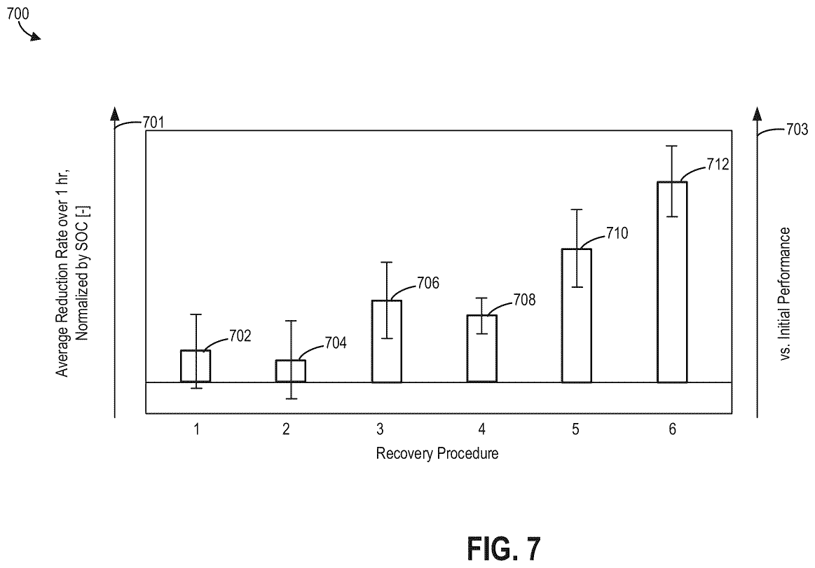

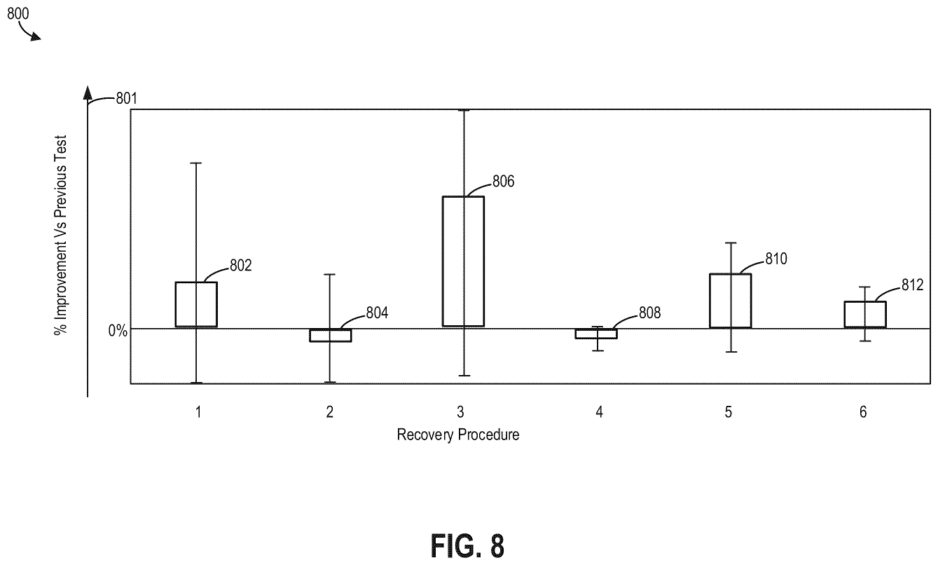

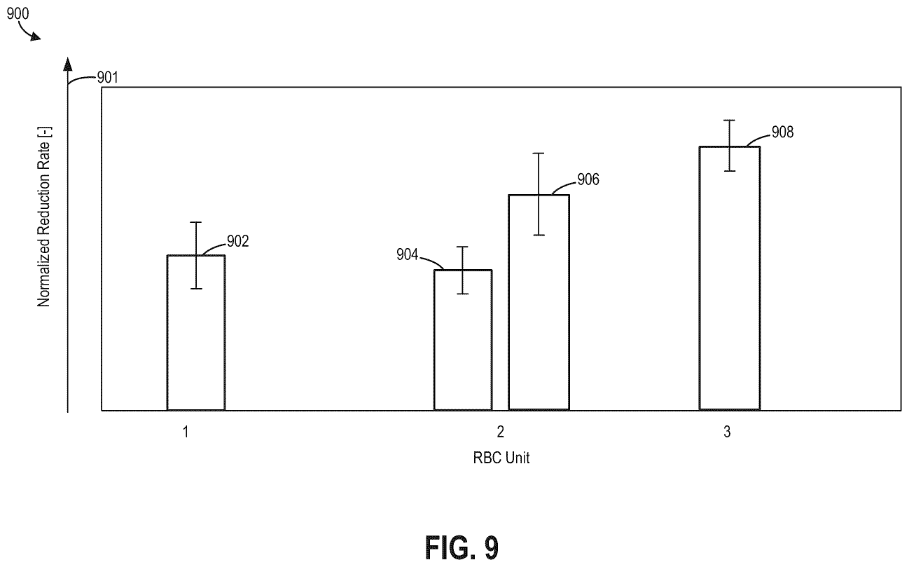

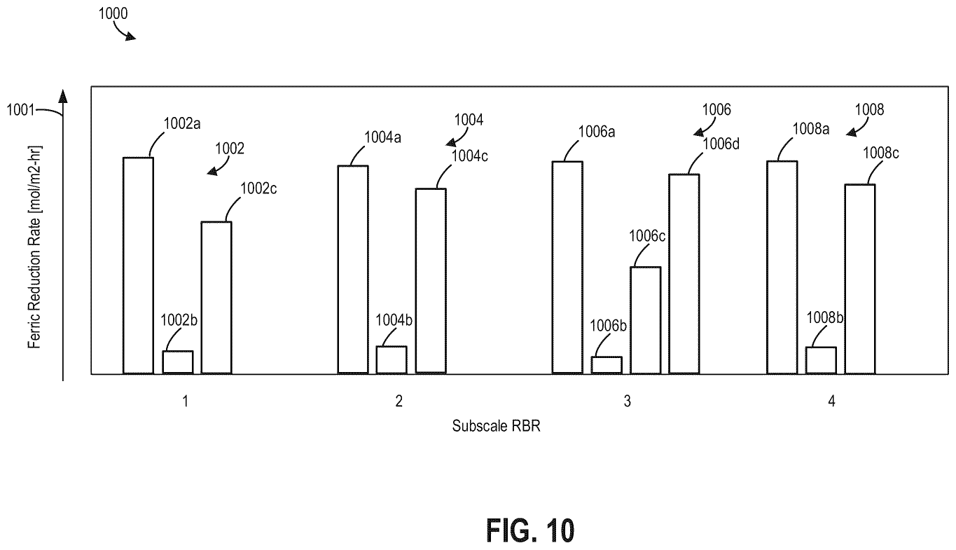

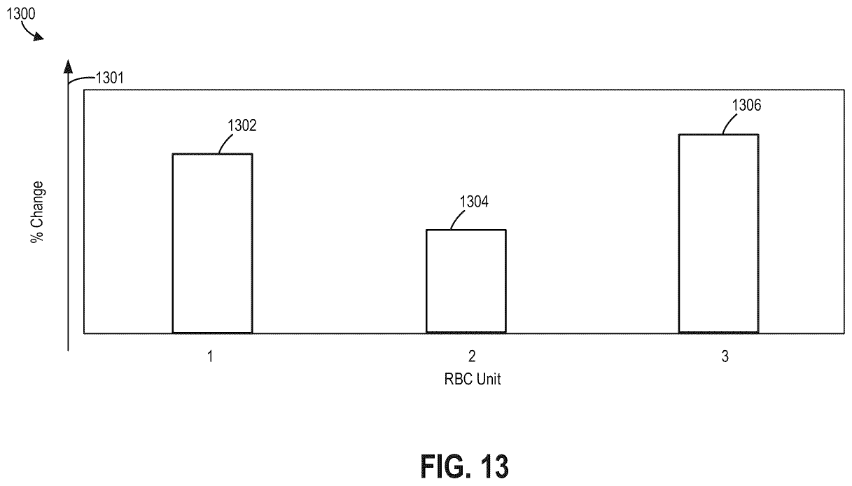

The following detailed description relates to systems and method for recovering performance of rebalancing systems. The rebalancing systems may be included in a redox flow battery system, such as the redox flow battery system shown in FIG. 1. The rebalancing systems may remediate electrolyte of the redox flow battery system by reacting hydrogen produced by side reactions of the flow battery system with Fe³⁺ to reduce the Fe³⁺ to Fe²⁺. As one example, the rebalancing system may be a rebalancing cell such as the rebalancing cell shown in FIG. 2. The rebalancing cell may include a plurality of electrode cells as shown in the exploded view of FIG. 3. In alternate examples, the rebalancing system may be a rebalancing reactor. An exemplary embodiment of a rebalancing reactor is shown in FIG. 4. A performance of a rebalancing system may decrease over time due, at least in part, to a double diffusion layer forming at a surface of a catalyst included in the rebalancing system. Herein, the performance of a rebalancing system may refer to a rate at which Fe³⁺ ions are reduced to Fe²⁺ ions. A flow chart of an example of a method for recovering performance of rebalancing system, such a rebalancing cell or a rebalancing reactor is shown in FIG. 5. The method may use a warm solution of trisodium citrate to remediate the diffusion double layer. Herein, sodium citrate may refer to mono-, di-, or trisodium citrate or hydrates thereof, or combinations thereof. Further, a warm citrate solution is considered, the warm citrate solution refers to a solution of any salt of the citrate anion or combinations of salts of the citrate anion including, for example sodium citrate, citric acid, and the like. A plot showing a decrease in rebalancing cell performance after prolonged use is shown in FIG. 6. The rebalancing cell of FIG. 6 is subjected to different recovery methods and subsequent recovery of reactor performance is shown in FIGS. 7-8. The exemplary recovery method may be used on different rebalancing systems including rebalancing cells including larger numbers of electrode cells as shown in the plot of FIG. 9. The exemplary recovery method of FIG. 5 may also be used to recover performance of a rebalancing reactor. Plots comparing degraded and recovered rebalancing reactor performance are shown in FIGS. 10-12. The exemplary method of FIG. 5 may also be used to recover different sized rebalancing reactors as shown in the plot of FIG. 13.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

Fe²⁺+2e⁻⇄Fe⁰ −0.44 V (negative electrode) (1)

Fe²⁺⇄2Fe³⁺+2e⁻+0.77 V (positive electrode) (2)

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCI), manganese (II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing system 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing systems 80 and 82 may be connected in line or in parallel with the recirculating flow paths of the electrolyte at the negative and positive sides of the redox flow battery cell 18, respectively, in the redox flow battery system 10. One or more rebalancing systems may be connected in-line with the recirculating flow paths of the electrolyte at the negative and positive sides of the battery, and other rebalancing systems may be connected in parallel, for redundancy (e.g., a rebalancing reactor may be serviced without disrupting battery and rebalancing operations) and for increased rebalancing capacity. In one example, the electrolyte rebalancing systems 80 and 82 may be placed in a return flow path from the negative and positive electrode compartments 20 and 22 to the negative and positive electrolyte chambers 50 and 52, respectively.

The rebalancing systems 80 and 82 may serve to rebalance electrolyte charge imbalances in the redox flow battery system 10 occurring due to side reactions, ion crossover, and the like, as described herein. In one example, electrolyte rebalancing systems 80 and 82 may be rebalancing reactors and may include trickle bed reactors and/or jelly roll reactors, where the H₂ gas and electrolyte may be contacted at catalyst surfaces in a packed bed for carrying out the electrolyte rebalancing reaction. In other examples, the rebalancing systems 80 and 82 may include flow-through type reactors that are capable of contacting the H₂ gas and the electrolyte liquid and carrying out the electrolyte rebalancing reactions absent a packed catalyst bed. For example, the rebalancing system may be a rebalancing cell including at least one electrode cell as discussed further below with respect to FIGS. 2-3.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing system 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi- chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, the controller may include instructions to determine a reduction rate of rebalancing systems 80 and 82. For rebalancing rates below a threshold rate, the controller may alert a user to perform a recovery method, such as the method discussed below with respect to FIG. 5. In some examples, the recovery method may be performed automatically by the controller. As another example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing systems 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

A rebalancing rate (e.g., performance) of a rebalancing system of redox flow battery system may decrease over time. The decrease in rebalancing rate may be due, at least in part, to formation of a diffusion double layer at a surface of a catalyst of the rebalancing system. The diffusion double layer may electrostatically repel hydrogen and ferric (Fe³⁺) ions from the catalyst, thereby decreasing performance of the rebalancing system. Previously, performance of the rebalancing system may be at least partially recovered by application of an electric charge and/or flushing with hot (e.g., 90° C.) water. Such methods may not be applicable across a wide range of rebalancing systems, such as those with a sealed architecture where application of an electric charge is not physically feasible or where components of the rebalancing system may degrade when exposed to water heated to 90° C. Instead, by using a combination of flushing and soaking steps with both room temperature water and a dilute warm (e.g., 60° C.) citrate solution, a method for recovering rebalancing rate compatible with a range of rebalancing systems may be provided. A combination of three carboxylic acid groups spaced apart by a relatively small distance in the citrate anion may make the anion particularly suited to recovering the performance of the rebalancing systems. In some examples, salts of other organic acids including carboxylic acid groups may be used in place of or in addition to citrate salts.

Referring now to FIG. 2, a perspective view 200 of a rebalancing cell 202 for a redox flow battery system, such as redox flow battery system 10 of FIG. 1 is shown. In an exemplary embodiment, the rebalancing cell 202 may include a stack of internally shorted electrode assemblies, such as an electrode assembly described in detail below with reference to FIG. 3. The rebalancing cell 202 may enable an electrolyte rebalancing reaction to occur by allowing H₂ gas to contact an electrolyte from positive or negative electrode compartments of a redox flow battery, such as the redox flow battery cell 18 of FIG. 1, at catalytic surfaces of negative electrodes of the stack of internally shorted electrode assemblies. Accordingly, the rebalancing cell 202 may be one or both of the rebalancing systems 80 and 82 of FIG. 1. A set of reference axes 201 is provided for describing relative positioning of the components shown and for comparison between the views of FIGS. 2 and 3, the axes 201 indicating an x-axis, a y-axis, and a z-axis. As further shown in dashing in FIGS. 2, an additional axis g may be parallel with a direction of gravity (e.g., in a positive direction along the axis g) and a vertical direction (e.g., in a negative direction along the axis g and opposite to the direction of gravity).

A number of the rebalancing cells 202 included in the redox flow battery system and a number of electrode assemblies included in the stack of internally shorted electrode assemblies are not particularly limited and may be increased to accommodate correspondingly higher performance applications. For example, a 75 kW redox flow battery system may include two rebalancing cells 202, each including a stack of 20 electrode assemblies (e.g., a stack of 19 bipolar assemblies with 2 endplates positioned at opposite ends of the stack).

As shown, the stack of internally shorted electrode assemblies may be removably enclosed within a housing or external cell enclosure 204. Accordingly, in some examples, the cell enclosure 204 may include a top cover removably affixed to an enclosure base, such that the top cover may be temporarily removed to replace or diagnose one or more electrode assemblies of the stack of internally shorted electrode assemblies. In additional or alternative examples, the cell enclosure 204, depicted in FIG. 2 as a rectangular prism, may be molded to be clearance fit against other components of the redox flow battery system such that the rebalancing cell 202 may be in face-sharing contact with such components. In some examples, the cell enclosure 204 may be composed of a material having a low electrical conductivity, such as a plastic or other polymer, so as to reduce undesirable shorting events.

The cell enclosure 204 may further be configured to include openings or cavities for interfacial components of the rebalancing cell 202. For example, the cell enclosure 204 may include a plurality of inlet and outlet ports configured to fluidically couple to other components of the redox flow battery system. In one example, and as shown, the plurality of inlet and outlet ports may include polypropylene (PP) flange fittings fusion welded to PP plumbing.

In an exemplary embodiment, the plurality of inlet and outlet ports may include an electrolyte inlet port 206 for flowing the electrolyte into the cell enclosure 204 and an electrolyte outlet port 208 for expelling the electrolyte from the cell enclosure 204. In one example, the electrolyte inlet port 206 may be positioned on an upper half of the cell enclosure 204 and the electrolyte outlet port 208 may be positioned on a lower half of the cell enclosure 204 (where the upper half and the lower half of the cell enclosure 204 are separated along the z-axis by a plane parallel with each of the x- and y-axes). Accordingly, the electrolyte outlet port 208 may be positioned lower than the electrolyte inlet port 206 with respect to the direction of gravity (e.g., along the axis g).

Specifically, upon the electrolyte entering the cell enclosure 204 via the electrolyte inlet port 206, the electrolyte may be distributed across the stack of internally shorted electrode assemblies, gravity fed through the stack of electrode assemblies, wicked up (e.g., against the direction of gravity) through positive electrodes of the stack of internally shorted electrode assemblies to react at the catalytic surfaces of the negative electrodes in a cathodic half reaction, and expelled out of the cell enclosure 204 via the electrolyte outlet port 208. To assist in the gravity feeding of the electrolyte and decrease a pressure drop thereof, the rebalancing cell 202 may further be tilted or inclined with respect to the direction of gravity via a sloped support 220 coupled to the cell enclosure 204. In some examples, tilting of the cell enclosure 204 in this way may further assist in electrolyte draining of the rebalancing cell 202 (e.g., during an idle mode of the redox flow battery system) and keep the catalytic surfaces relatively dry (as the catalytic surfaces may corrode after being soaked in the electrolyte for a sufficient duration, in some examples).

As shown, the sloped support 220 may tilt the cell enclosure 204 at an angle 222 such that planes of electrode sheets of the stack of internally shorted electrode assemblies are inclined with respect to a lower surface (not shown) on which the sloped support 220 rests at the angle 222. In some examples, the angle 222 (e.g., of the cell enclosure 204 with respect to the lower surface) may be between 0° and 30° (in embodiments wherein the angle 222 is substantially 0°, the rebalancing cell 202 may still function, though the pressure drop may be greater and electrolyte crossover to the negative electrodes may be reduced when the cell enclosure 204 is tilted). In some examples, the angle 222 may be between 2° and 30°. In some examples, the angle 222 may be between 2° and 20°. In one example, the angle 222 may be about 8°. Accordingly, the pressure drop of the electrolyte may be increased by increasing the angle 222 and decreased by decreasing the angle 222. Additionally or alternatively, one or more support rails 224 may be coupled to the upper half of the cell enclosure 204 (e.g., opposite from the sloped support 220). In some examples, and as shown in the perspective view 200 of FIG. 2, the one or more support rails 224 may be tilted with respect to the cell enclosure 204 at the angle 222 such that the one or more support rails 224 may removably fasten the rebalancing cell 202 to an upper surface above and parallel with the lower surface. In this way, and based on geometric considerations, the z-axis may likewise be offset from the axis g at the angle 222 (e.g., the cell enclosure 204 may be tilted with respect to a vertical direction opposite the direction of gravity by the angle 222, as shown in FIG. 2). In some examples, gravity feeding of the electrolyte through the rebalancing cell 202 may further be assisted by positioning the rebalancing cell 202 above an electrolyte storage tank (e.g., the multi-chambered electrolyte storage tank 110 of FIG. 1) of the redox flow battery system with respect to the vertical direction opposite to the direction of gravity.

As further shown, the electrolyte outlet port 208 may include a plurality of openings in the cell enclosure 204 configured to expel at least a portion of the electrolyte (each of the plurality of openings including the PP flange fitting fusion welded to PP plumbing). For instance, in FIG. 2, the electrolyte outlet port 208 is shown including five openings. In this way, the electrolyte may be evenly distributed across the stack of internally shorted electrode assemblies and may be expelled from the cell enclosure 204 with substantially unimpeded flow. In other examples, the electrolyte outlet port 208 may include more than five openings or less than five openings. In one example, the electrolyte outlet port 208 may include only one opening. In additional or alternative examples, the electrolyte outlet port 208 may be positioned beneath the cell enclosure 204 with respect to the z-axis (e.g., on a face of the cell enclosure 204 facing a negative direction of the z-axis).

The electrolyte inlet port 206 and the electrolyte outlet port 208 may be positioned on the cell enclosure 204 based on a flow path of the electrolyte through the stack of internally shorted electrode assemblies (e.g., from the electrolyte inlet port 206 to the electrolyte outlet port 208 and inclusive of channels, passages, plenums, wells, etc. within the cell enclosure 204 fluidically coupled to the electrolyte inlet port 206 and the electrolyte outlet port 208). In some examples, and as shown, the electrolyte inlet port 206 and the electrolyte outlet port 208 may be positioned on adjacent sides of the cell enclosure 204 (e.g., faces of the cell enclosure 204 sharing a common edge). In other examples, the electrolyte inlet port 206 and the electrolyte outlet port 208 may be positioned on opposite sides of the cell enclosure 204. In other examples, the electrolyte inlet port 206 and the electrolyte outlet port 208 may be positioned on the same side of the cell enclosure 204.

In some examples, the electrolyte inlet port 206 may be positioned on a face of the cell enclosure 204 facing a negative direction of the x-axis. In additional or alternative examples, the electrolyte inlet port 206 may be positioned on a face of the cell enclosure 204 facing a positive direction of the x-axis. In one example, and as shown, one opening of the electrolyte inlet port 206 may be positioned on the face of the cell enclosure 204 facing the negative direction of the x-axis and another opening of the electrolyte inlet port 206 may be positioned on the face of the cell enclosure 204 facing the positive direction of the x-axis.

In some examples, the plurality of inlet and outlet ports may further include a hydrogen gas inlet port 210 for flowing the H₂ gas into the cell enclosure 204 and a hydrogen gas outlet port positioned opposite hydrogen gas inlet port 210 across the x-axis for expelling the H₂ gas from the cell enclosure 204. In one example, and as shown, each of the hydrogen gas inlet port 210 and the hydrogen gas outlet port may be positioned on the lower half of the cell enclosure 204 (e.g., at a lowermost electrode assembly of the stack of internally shorted electrode assemblies along the z-axis). In another example, each of the hydrogen gas inlet port 210 and the hydrogen gas outlet port may be positioned on the upper half of the cell enclosure 204 (e.g., at an uppermost electrode assembly of the stack of internally shorted electrode assemblies along the z-axis). In yet another example, the hydrogen gas inlet port 210 may be positioned on the lower half of the cell enclosure 204 and the hydrogen gas outlet port may be positioned on the upper half of the cell enclosure 204. In such an example, the hydrogen gas inlet port 210 may be positioned lower than the hydrogen gas outlet port with respect to the direction of gravity (e.g., along the axis g).

Specifically, upon the H₂ gas entering the cell enclosure 204 via the hydrogen gas inlet port 210, the H₂ gas may be distributed across and through the stack of internally shorted electrode assemblies via forced convection (e.g., induced by flow field configurations of respective flow field plates) and decomposed at the catalytic surfaces of the negative electrodes in an anodic half reaction. However, in some examples, excess, unreacted H₂ gas may remain in the rebalancing cell 202 following contact with the catalytic surfaces. In some examples, at least a portion of the H₂ gas which has not reacted at the catalytic surfaces may pass into the electrolyte. To avoid undesirable pressure buildup and thereby prevent electrolyte pooling on the positive electrodes and concomitant electrolyte flooding of the negative electrodes in such examples, the plurality of inlet and outlet ports may further include a pressure release outlet port 214 to expel unreacted H₂ gas from the electrolyte. Further, in some examples, the hydrogen gas outlet port may be configured to expel at least a portion of the H₂ gas which has not reacted at the catalytic surfaces and that has not flowed through the negative electrodes into the electrolyte.

The hydrogen gas inlet port 210 and the hydrogen gas outlet port may be positioned on the cell enclosure 204 based on a flow path of the H₂ gas through the stack of internally shorted electrode assemblies [e.g., from the hydrogen gas inlet port 210 to the hydrogen gas outlet port (when included) and inclusive of channels, passages, plenums, etc. within the cell enclosure 204 fluidically coupled to the hydrogen gas inlet port 210 and the hydrogen gas outlet port (when included)]. In some examples, and as shown, the hydrogen gas inlet port 210 and the hydrogen gas outlet port may be positioned on opposite sides of the cell enclosure 204. In other examples, the hydrogen gas inlet port 210 and the hydrogen gas outlet port may be positioned on adjacent sides of the cell enclosure 204. In other examples, the hydrogen gas inlet port 210 and the hydrogen gas outlet port may be positioned on the same side of the cell enclosure 204. Further, though the hydrogen gas inlet port 210 is shown in FIG. 2 as being positioned on the face of the cell enclosure 204 facing the negative direction of the x-axis and the hydrogen gas outlet port may be positioned on the face of the cell enclosure 204 facing the positive direction of the x-axis, in other examples, the hydrogen gas inlet port 210 may be positioned on the face of the cell enclosure 204 facing the positive direction of the x-axis and the hydrogen gas outlet port may be positioned on the face of the cell enclosure 204 facing the negative direction of the x-axis.

In one example, the hydrogen gas inlet port 210, the hydrogen gas outlet port, the electrolyte inlet port 206, and the electrolyte outlet port 208 may be positioned on the cell enclosure 204 in a crosswise configuration. Specifically, the crosswise configuration may include the hydrogen gas outlet port and the electrolyte inlet port 206 being positioned on different sides (e.g., faces) of the upper half of the cell enclosure 204 and the hydrogen gas inlet port 210 and the electrolyte outlet port 208 being positioned on different sides of the lower half of the cell enclosure 204.

In other examples, no hydrogen gas outlet port may be present for expelling H₂ gas which has not reacted at the catalytic surfaces of the negative electrodes and which has not flowed through the negative electrodes into the electrolyte. In such examples, however, the pressure release outlet port 214 for expelling unreacted H₂ gas from the electrolyte may still be present, and the unreacted H₂ gas may only be expelled from the cell enclosure 204 after flowing through the negative electrodes into the electrolyte and through the pressure release outlet port 214. Exemplary rebalancing cell configurations lacking the hydrogen gas outlet port, whether or not including the pressure release outlet port 214, may be referred to as “dead ended configurations.” In dead ended configurations, substantially all of the H₂ gas may be forced into contact with the catalytic surfaces of the negative electrodes, whereat the H₂ gas may either decompose via the anodic half reaction and/or the H₂ gas may enter the electrolyte after passing through the negative electrodes (e.g., without reacting at catalytic surfaces thereof).

Referring now to FIG. 3, an exploded view 300 depicting an electrode assembly (e.g., electrode cell) 302 for a rebalancing cell, such as the rebalancing cell 202 of FIG. 2, is shown. Accordingly, the electrode assembly 302 may be internally shorted (e.g., electric current flowing through the electrode assembly 302 is not channeled through an external load). In an exemplary embodiment, the electrode assembly 302 may be included in a stack of electrode assemblies of like configuration in a cell enclosure so as to form the rebalancing cell. The electrode assembly 302 may include a plate 304 with an activated carbon foam 306, a positive electrode 308 (also referred to herein as a “cathode” in certain examples), and a negative electrode 310 (also referred to herein as an “anode” in certain examples) sequentially stacked thereon. In one example, the plate 304 may be a bipolar plate. The electrode assembly 302 may be positioned within the rebalancing cell so as to receive an electrolyte through the carbon foam 306, wherefrom the electrolyte may enter pores of the positive electrode 308 via capillary action and come into contact with the negative electrode 310. The electrode assembly 302 may further be positioned within the rebalancing cell so as to receive H₂ gas across a catalytic surface of the negative electrode 310 opposite to the positive electrode 308 via convection. The convection of the H₂ gas across the catalytic surface may be assisted by a flow field plate (not shown at FIG. 3) interfacing with the catalytic surface. Upon decomposition of the H₂ gas at the catalytic surface via an anodic half reaction, protons and electrons may flow to an interface of the negative electrode 310 and the positive electrode 308, whereat ions in the electrolyte may be reduced via a cathodic half reaction (e.g., Fe³⁺ may be reduced to Fe²⁺). In this way, the electrode assembly 302 may be configured for electrolyte rebalancing for a redox flow battery, such as the redox flow battery cell 18 of FIG. 1, fluidically coupled to the rebalancing cell including the electrode assembly 302.

In some examples, the plate 304 may be composed of a material having a low electrical conductivity, such as a plastic or other polymer, so as to reduce undesirable shorting events. Accordingly, in one example, the plate 304 may be formed from the same material as the cell enclosure 204 of FIG. 2.

As shown, the plate 304 may include a plurality of inlets and outlets therethrough. For example, the plurality of inlets and outlets may include an electrolyte outlet channel section 316, a hydrogen gas inlet channel section 318a, and a hydrogen gas outlet channel section 318b. Specifically, the plate 304 may include the electrolyte outlet channel section 316 for directing the electrolyte out of the rebalancing cell, the hydrogen gas inlet channel section 318a for directing the H₂ gas into the rebalancing cell and across the negative electrode 310, and the hydrogen gas outlet channel section 318b for directing the H₂ gas out of the rebalancing cell. The plate 304 may further include an electrolyte inlet well 312 for receiving the electrolyte at the electrode assembly 302, the electrolyte inlet well 312 fluidically coupled to a plurality of electrolyte inlet passages 314a set into a berm 314b positioned adjacent to the carbon foam 306 for distributing the received electrolyte across the carbon foam 306. In some examples, the electrolyte inlet well 312 may receive the electrolyte from an electrolyte inlet port (e.g., the electrolyte inlet port 206 of FIG. 2) fluidically coupled thereto (e.g., via an electrolyte inlet channel; not shown at FIG. 3), the electrolyte outlet channel section 316 may expel the electrolyte through an electrolyte outlet port (e.g., the electrolyte outlet port 208 of FIG. 2) fluidically coupled thereto, the hydrogen gas inlet channel section 318a may receive the H₂ gas from a hydrogen gas inlet port (e.g., the hydrogen gas inlet port 210 of FIG. 2) fluidically coupled thereto, and the hydrogen gas outlet channel section 318b may expel the H₂ gas through a hydrogen gas outlet port fluidically coupled thereto.

It will be appreciated that, though the hydrogen gas inlet channel section 318a is described herein as a section of a hydrogen gas inlet channel and the hydrogen gas outlet channel section 318b is described herein as a section of a hydrogen gas outlet channel, in other examples, the channel section 318b may be a section of a hydrogen gas inlet channel (e.g., for directing the H₂ gas into the rebalancing cell and across the negative electrode 310 after receiving the H₂ gas from the hydrogen gas inlet port) and the channel section 318a may be a section of a hydrogen gas outlet channel (e.g., for directing the H₂ gas out of the rebalancing cell by expelling the H₂ gas through the hydrogen gas outlet port). In other examples, the rebalancing cell may have a dead ended configuration and no hydrogen gas outlet port may be fluidically coupled to the hydrogen gas outlet channel section 318b. In such examples, the hydrogen gas outlet channel section 318b may direct the H₂ gas back across the negative electrode 310 or the hydrogen gas outlet channel section 318b may instead be configured as another hydrogen gas inlet channel section (e.g., for directing a portion of the H₂ gas into the rebalancing cell and across the negative electrode 310 after receiving the portion of the H₂ gas from the hydrogen gas inlet port).

The plurality of inlets and outlets may be configured to control electrolyte and H₂ gas flow throughout the rebalancing cell. As an example, a size of each of the hydrogen gas inlet channel section 318a and the hydrogen gas outlet channel section 318b may be selected to minimize a pressure drop therethrough, thereby aiding in flow distribution into each electrode assembly 302 of the stack of internally shorted electrode assemblies. As another example, a size of each electrolyte inlet passage 314a and a total number of the plurality of electrolyte inlet passages 314a relative to the berm 314b may be selected to induce a relatively small pressure drop to substantially evenly distribute electrolyte flow. In such an example, the selection of the size of each electrolyte inlet passage 314a and the total number of the plurality of electrolyte inlet passages 314a may be dependent on a number of factors specific to a given configuration of the rebalancing cell, such as a size of an electrolyte flow field and a desired electrolyte flow rate.

In additional or alternative examples, the electrolyte outlet channel section 316 may further be configured for distributing the electrolyte through multiple openings included in the electrolyte outlet port. For instance, in the exploded view 300 of FIG. 3, the electrolyte outlet channel section 316 is shown including two openings. In some examples, a number of openings included in the electrolyte outlet channel section 316 may be equal to a number of openings included in the electrolyte outlet port, such that the openings of the electrolyte outlet channel section 316 may respectively correspond to the openings of the electrolyte outlet port. In this way, the electrolyte may be evenly distributed across the electrode assembly 302 and may be expelled from the rebalancing cell with substantially unimpeded flow. In other examples, the electrolyte outlet channel section 316 may include more than two openings or less than two openings (e.g., only one opening).

Further, when the electrode assembly 302 is included in a stack of electrode assemblies, electrolyte outlet channel sections 316, hydrogen gas inlet channel sections 318a, and hydrogen gas outlet channel sections 318b may align to form a continuous electrolyte outlet channel, a continuous hydrogen gas inlet channel, and a continuous hydrogen gas outlet channel, respectively). In this way, the stack of electrode assemblies may be formed in a modular fashion, whereby any practical number of electrode assemblies 302 may be stacked and included in a rebalancing cell.

As further shown, a plurality of sealing inserts may be affixed (as used herein, “affix,” “affixed,” or “affixing” includes, but is not limited to, gluing, attaching, connecting, fastening, joining, linking, or securing one component to another component through a direct or indirect relationship) or otherwise coupled to the plate 304. As an example, the plurality of sealing inserts may include a hydrogen gas inlet channel seal insert 320a and a hydrogen gas outlet channel seal insert 320b for inducing flow of the H₂ gas across the negative electrode 310 by mitigating H₂ gas bypass. Specifically, the hydrogen gas inlet channel seal insert 320a and the hydrogen gas outlet channel seal insert 320b may be affixed or otherwise coupled adjacent to the hydrogen gas inlet channel section 318a and the hydrogen gas outlet channel section 318b, respectively, on a side of the plate 304 including the carbon foam 306, the positive electrode 308, and the negative electrode 310. In some examples, the hydrogen gas inlet channel seal insert 320a and the hydrogen gas outlet channel seal insert 320b may be coincident with an x-y plane of the negative electrode 310 such that the hydrogen gas inlet channel seal insert 320a and the hydrogen gas outlet channel seal insert 320b may extend from a locus of affixation or coupling with the plate 304 and partially overlap the positive electrode 308.

As another example, the plurality of sealing inserts may further include each of a hydrogen gas inlet channel O-ring 322a and a hydrogen gas outlet channel O-ring 322b for respectively sealing an interface of the hydrogen gas inlet channel section 318a with a hydrogen gas inlet channel section of another electrode assembly and an interface of the hydrogen gas outlet channel section 318b with a hydrogen gas outlet channel section of another electrode assembly. Specifically, the hydrogen gas inlet channel O-ring 322a and the hydrogen gas outlet channel O-ring 322b may be affixed or otherwise coupled to the plate 304 so as to respectively circumscribe the hydrogen gas inlet channel section 318a and the hydrogen gas outlet channel section 318b.

As another example, the plurality of sealing inserts may further include an overboard O-ring 324 for sealing an interface of the electrode assembly 302 with another electrode assembly at outer edges thereof. Specifically, the overboard O-ring 324 may be affixed or otherwise coupled to the plate 304 so as to circumscribe each of the electrolyte inlet well 312, the plurality of electrolyte inlet passages 314a, the berm 314b, the electrolyte outlet channel section 316, the hydrogen gas inlet channel section 318a, and the hydrogen gas outlet channel section 318b.

The carbon foam 306 may be positioned in a cavity 326 of the plate 304 between the berm 314b and the electrolyte outlet channel section 316 along the y-axis and between the hydrogen gas inlet channel section 318a and the hydrogen gas outlet channel section 318b along the x-axis. Specifically, the carbon foam 306 may be positioned in face-sharing contact with a side of the plate 304 forming a base of the cavity 326. In some examples, the carbon foam 306 may be formed as a continuous monolithic piece, while in other examples, the carbon foam 306 may be formed as two or more carbon foam sections. In an exemplary embodiment, the carbon foam 306 may be conductive, permeable, and porous, providing a distribution field for the electrolyte being gravity fed therethrough from the plurality of electrolyte inlet passages 314a. In some examples, a pore distribution of the carbon foam 306 may be between 10 and 100 PPI. In one example, the pore distribution may be 30 PPI. In additional or alternative examples, a permeability of the carbon foam 306 may be between 0.02 and 0.5 mm². As such, each of the pore distribution and the permeability, in addition to an overall size, of the carbon foam 306 may be selected to target a relatively small pressure drop and thereby induce convection of the electrolyte from the carbon foam 306 into the positive electrode 308. For example, the pressure drop may be targeted to between 2 to 3 mm of electrolyte head rise.

In some examples, the carbon foam 306 may be replaced with a flow field plate configured to transport the electrolyte into the positive electrode 308 via convection induced by a flow field configuration of the flow field plate. Specifically, the flow field plate may be fluidically coupled to each of the plurality of electrolyte inlet passages 314a and the electrolyte outlet channel section 316. In one example, the flow field plate may be integrally formed in the plate 304 of the electrode assembly 302, positioned beneath the positive electrode 308 with respect to the z-axis. In other examples, the flow field plate may be a separate, removable component.

In some examples, the flow field configuration may be an interdigitated flow field configuration, a partially interdigitated flow field configuration, or a serpentine flow field configuration. In some examples, each electrode assembly 302 may interface with a flow field configuration of like configuration (e.g., interdigitated, partially interdigitated, serpentine, etc.) as each other electrode assembly 302. In other examples, a number of different flow field configurations may be provided among the electrode assemblies 302 in the stack of electrode assemblies (e.g., dependent upon a location of a given electrode assembly 302 in the rebalancing cell 202 of FIG. 2). In this way, the electrolyte may be directed from the electrolyte inlet port (e.g., the electrolyte inlet port 206 of FIG. 2) to the flow field plates respectively interfacing with the positive electrodes 308 in the stack of electrode assemblies, the flow field plates being configured in interdigitated flow field configurations, partially interdigitated flow field configurations, serpentine flow field configurations, or a combination thereof.

In certain examples, another flow field plate (also referred to herein as a “hydrogen gas flow field plate”) may interface with the negative electrode 310 opposite from the positive electrode 308 with respect to the z-axis. However, in other examples, only the electrolyte flow field plate may be included (e.g., replacing the carbon foam 306) and no hydrogen gas flow field plate may be present. In still other examples, only the hydrogen gas flow field plate may be included (e.g., interfacing with the negative electrode 310) and no electrolyte flow field plate may be present.

The positive electrode 308 may be positioned in the cavity 326 in face-sharing contact with a side of the carbon foam 306 opposite from the plate 304 along the z-axis. In an exemplary embodiment, the positive electrode 308 may be a wicking conductive carbon felt, sponge, or mesh which may bring the electrolyte flowing through the carbon foam 306 into contact with the negative electrode 310 via capillary action. Accordingly, in some examples, the positive electrode 308 may be conductive and porous (though less porous than the carbon foam 306 in such examples). In one example, the electrolyte may be wicked into the positive electrode 308 when the porosity of the carbon foam 306 is within a predefined range (e.g., below an upper threshold porosity so as to retain enough solid material to promote wicking up and into the positive electrode 308 and above a lower threshold porosity so as to not impede electrolyte flow through the carbon foam 306). In an additional or alternative example, each of a sorptivity of the positive electrode 308 may decrease and a permeability of the positive electrode 308 may increase with an increasing porosity of the positive electrode 308 (e.g., at least until too little solid material of the positive electrode 308 remains to promote wicking of the electrolyte, such as when a critical porosity of the positive electrode 308 is reached). In some examples, surfaces of the positive electrode 308 may be sufficiently hydrophilic for desirable rebalancing cell operation (e.g., by facilitating thorough electrolyte wetting and thereby forming an ionically conductive medium). In such examples, an overall hydrophilicity of the positive electrode 308 may be increased by coating or treating the surfaces thereof. Further, though at least some of the H₂ gas may pass into the positive electrode 308 in addition to a portion of the electrolyte wicked into the positive electrode 308, the positive electrode 308 may be considered a separator between a bulk of the H₂ gas thereabove and a bulk of the electrolyte therebelow.

In some examples, each of the positive electrode 308 and the negative electrode 310 may be formed as a continuous monolithic piece (e.g., as opposed to discrete particles or a plurality of pieces), such that interphase mass-transport losses across boundary layer films may be reduced when bringing the electrolyte into contact with the H₂ gas at the catalytic surfaces of the negative electrode 310, thereby promoting ionic and proton movement.

The negative electrode 310 may be positioned in the cavity 326 in face-sharing contact with a side of the positive electrode 308 opposite from the carbon foam 306 along the z-axis, such that a three-phase contact interface between the (wicked) electrolyte, the catalytic surfaces of the negative electrode 310, and the H₂ gas may be formed for proton (e.g., H⁺) and ionic movement (H₃O⁺) therethrough. In tandem, the positive electrode 308 may reduce an overall electronic resistance by providing a conductive path for electrons to move into the electrolyte front and reduce Fe³⁺ ions thereat.

In an exemplary embodiment, the negative electrode 310 may be a porous non-conductive material or a conductive carbon substrate with a metal catalyst coated thereon. In some examples, the porous non-conductive material may include polytetrafluoroethylene (PTFE), polypropylene, or the like. In some examples, the conductive carbon substrate may include carbon cloth or carbon paper. In some examples, the metal catalyst may include a precious metal catalyst. In some examples, the precious metal catalyst may include Pt. In additional or alternative examples, the precious metal catalyst may include Pd, Rh, Ru, Ir, Ta, or alloys thereof. In some examples, a relatively small amount (e.g., 0.2 to 0.5 wt %) of the precious metal catalyst supported on the conductive carbon substrate may be employed for cost considerations. In practice, however, the amount of the precious metal catalyst is not particularly limited and may be selected based on one or more of a desired rate of reaction for the rebalancing cell and an expected lifetime of the rebalancing cell. Furthermore, alloys included in the precious metal catalyst may be utilized to reduce cost and increase a corrosion stability of the precious metal catalyst. For example, 10% addition of Rh to Pt may reduce corrosion of Pt by Fe³⁺ by over 98%. In other examples, the metal catalyst may include a non-precious metal catalyst selected for stability in ferric solution and other such acidic environments (e.g., molybdenum sulfide). In one example, the negative electrode 310 may include carbon cloth coated with 1.0 mg/cm² Pt and may include a microporous layer bound with a polytetrafluoroethylene (PTFE) binder (e.g., for hydrophobicity). Indeed, inclusion of the PTFE binder may increase a durability of rebalancing cell performance over extended durations relative to electrode assemblies formed using other binders.

In other examples, an activity of the catalyst in the negative electrode 310 may be maintained by rinsing the negative electrode 310 with a water (e.g., up 60° C.) solution of citric acid in combination with rinsing and soaking with deionized water. The method for recovering catalyst activity is discussed further below with respect to FIG. 5.

Turning now to FIG. 4, an example of a catalyst bed 400 which may be included in a rebalancing reactor is shown. Axes 401 are provided for reference, including an x-axis, y-axis, and z-axis. The catalyst bed 400 may be formed by coating a substrate layer 404 with a catalyst layer 406. One or both sides of the substrate layer 404 may be coated with the catalyst layer 406. Coating both sides of the substrate layer 404 may increase a redox reaction rate of the catalyst bed 400 as compared to coating a single side of the substrate layer 404.

Substrate layer 404 may include a flexible and bendable substrate such as carbon cloth, carbon paper, or another type of membrane. Substrate layer 404 may be porous or non-porous, and/or permeable to hydrogen gas, hydrogen ions, and to electrolyte, such as positive electrolyte and negative electrolyte from positive electrolyte chamber 52 and negative electrolyte chamber 50 of FIG. 1. Substrate layer 404 may further be inert with respect to hydrogen gas, hydrogen ions, and the electrolyte including both the positive electrolyte and the negative electrolyte. A thickness of the substrate layer 404 may be small enough so as not to substantially hinder diffusion or convective transport of electrolyte species through the substrate layer 404. For example, when the substrate layer 404 is thinner than 0.5 mm, reaction rates may be higher as compared to when the substrate layer 404 is thicker than 0.5 mm.

The substrate layer 404 may be conductive, semi-conductive, or non-conductive. Conductive substrate layers may yield higher reaction rates as compared to non-conductive substrate layers. For example, a carbon substrate (e.g., carbon cloth, carbon paper, and the like) may aid in electron transfer, and provides a catalytic surface for the ferric/ferrous ion redox reaction. Some example membrane materials that may be utilized for the substrate layer 404 include polypropylene, polyolefin, perfluoroalkoxy (PFA), polysulfone amide (PSA), and the like. In addition, the substrate layer 404 may comprise a thin ceramic sheet or a thin metal sheet, provided the substrate layer 404 does not react with ferric ions.

Catalyst layer 406 may include one or more different types of catalyst materials such as platinum, palladium, ruthenium, and alloys thereof. The weight percent of the catalyst material on the substrate layer 304 may be from 0.2 wt % to greater than 0.5 wt %. The substrate layer 404 coated with the catalyst layer 406 may be porous and permeable to hydrogen gas, hydrogen ions, and to electrolyte including the positive electrolyte and the negative electrolyte. When hydrogen gas and metal ions in the electrolyte are fluidly contacted at the catalyst layer 306, the catalyst layer 406 may catalyze a redox reaction whereby the hydrogen gas may be oxidized to hydrogen ions and the metal ions may be reduced. The substrate layer 404 may be coated entirely with the catalyst layer 406 to increase a redox reaction rate of hydrogen gas and metal ions at the catalyst layer surface.

The spacing layers 410 may extend across the entire axial dimension, e.g., along the y-axis, of the jelly roll structured catalyst bed 420, as indicated by dashed lines. When coiled into the jelly roll structure as shown in FIG. 4, the jelly roll structured catalyst bed 420 has a cylindrical shape. The cylindrical, rolled configuration of the jelly roll structured catalyst bed 420 may allow the jelly roll structured catalyst bed 420 to be removed as a single unit, reducing time and costs of maintenance of a rebalancing reactor. Electrolyte may be flowed through the jelly roll structured catalyst bed 420, the flow in contact with the catalyst bed 420 for a prolonged period of time in comparison to packed catalyst beds, increasing an efficiency of the jelly roll structured catalyst bed 420 in facilitating hydrogen oxidation and iron reduction.

A conductive wire 430, may be woven through the catalyst layer 406 so that the conductive wire 430 is in close proximity to the catalyst material, e.g., in contact with or near catalyst sites. The conductive wire 430 may have a linear, sinuous, zig zag, etc. layout across the z-x plane in the catalyst layer 406 and extend out of the catalyst bed 400 to couple to an electrical energy storage device 432, hereafter battery 432. A voltage supplied by the battery 432 may be conducted to the catalyst layer 406 via the conductive wire 430.

The rebalancing reactor may further include an outer housing. The jelly roll structure catalyst bed 420 may be inserted into the outer housing that is also cylindrical to match a shape of the jelly roll structure catalyst bed 420, sliding in and out of the housing along a central axis of rotation of the cylindrical outer housing. The outer housing may include one or more inlets configured to receive a fluid (e.g., electrolyte suffused with hydrogen gas to be rebalanced) and one or more outlets configured to output the treated fluid.

Turning now to FIG. 5, a flow chart showing a method 500 for recovering performance of a rebalancing system, such as the rebalancing cell of FIGS. 2-3 or the rebalancing reactor of FIG. 4 is shown. The rebalancing cell may include at least 1 electrode cell. The rebalancing system may be similar to rebalancing systems 80 and/or 82 of FIG. 1 and may be included in a redox flow battery system, such as redox flow battery system 10 of FIG. 1. In some examples the rebalancing system may be a large scale rebalancing system. In an example where the rebalancing system is a large scale rebalancing reactor, a surface area (geometric) of a catalyst roll of the rebalancing reactor may be above or equal to a threshold surface area of 1 m². In an example where the rebalancing system is a rebalancing cell, the large scale rebalancing cell may include greater than or equal to 30 electrode cells.

Method 500 may be at least partially executed by a controller, such as controller 88, based on executable instructions stored in a non-transitory memory of the controller. In some examples method 500 may be executed in response to a reduction rate of the rebalancing system dropping below a threshold reduction rate. For example, the controller may indicate a request to recover the rebalancing system using citrate solution in response to the reduction rate dropping below the threshold reduction rate. The threshold reduction rate may be a rate below which pH of the electrolyte may increase and cause precipitation of iron hydroxides and otherwise decrease efficiency of the redox flow battery system. As one example, the threshold reduction rate may be 0.6 mol/m²-hr. In further examples, method 500 may be executed in response to sensing a diminished performance of the redox flow battery system. For example, method 500 may be executed in response to a measured pH of the electrolyte being outside a range or a state of charge (SOC) of the redox flow battery being below a threshold SOC.

At 501, method 500 includes pretreating the rebalancing system with pretreating water. Pretreating the rebalancing system may remove acidic electrolyte and any other possible precipitants from the rebalancing reactor. After pretreating the rebalancing system, a pH of water passed through the rebalancing system may no longer be acidic after pretreatment. Pretreating the rebalancing system with water may include a flushing step followed by a circulating step followed by another flushing step, in order as described below with respect to steps 502, 504, and 506 which together may comprise pretreating the rebalancing system.

At 502, method 500 includes flushing the rebalancing system with a first amount of water. In some examples, the first amount of water is deionized water or distilled water. In alternate examples, the first amount of water may be tap water. Flushing the rebalancing system may include disconnecting an electrolyte inlet and outlet of the rebalancing system from an electrolyte system of the redox flow battery system and fluidly coupling the inlet to a source of water. During flushing, the water may exit the rebalancing system from the outlet and may be directed to waste. In this way, the water may flow through electrolyte passages of the rebalancing system during flushing. The first amount of water may be at ambient temperature and the temperature may not be controlled to be hotter or colder. For example, the first amount of water may be at room temperature. As another example, the first amount of water may be 20° C. or approximately 20° C. In alternate examples, the first amount of water may be a temperature in a range between a freezing point and a boiling point of the first amount of water. In alternate examples, the first amount of water may be a temperature in a range between room temperature and a boiling point of the first amount of water. The first amount of water may be sufficient to wash remaining electrolyte from within the rebalancing system. In this way a pH of water in the rebalancing system may not be substantially acidic after flushing. The pH of water in the rebalancing system may be approximately (herein approximately may refer to within +/−5%) the same as a pH of the first amount of water used for flushing. As one example, the first amount of water may be at 50 L. In some examples, the first amount of water may depend on an area of catalyst included in the rebalancing system. For example, the first amount of water may be between 5-100 L/m² of catalyst. A first amount of water larger than a desired range may not decrease an effectiveness of method 500. In some examples the first amount of water may be greater than or equal to 5 L/m² of catalyst.

At 504, method 500 includes circulating a second amount of water through the rebalancing system for a first duration. Circulating the second amount of water may include coupling the outlet of the rebalancing system to the inlet of rebalancing system. In this way, the water is passed multiple times through electrolyte passages of the rebalancing system. The second amount of water may be deionized water or distilled water. In alternate examples, the second amount of water may be tap water. As one example, the second amount of water may be at ambient temperature and/or room temperature. As an alternate example, a temperature of the second amount of water may be in range of a freezing point to a boiling point of the second amount of water. In alternate examples, the temperature of the second amount of water may be in a range of room temperature to a boiling point of the second amount of water. Further, the second amount of water may be 50 L. In some examples, the second amount of water may depend on an area of catalyst included in the rebalancing system. For example, the second amount of water may be between 5-60 L/m² of catalyst. A second amount of water larger than a desired range may not decrease effectiveness of method 500. In some examples, the second amount of water may be at greater than or equal to 5 L/m². Additionally, the first duration may be in a range of 5 min to 5 hours. In some examples the first duration may be one hour. Increasing the first duration past a desired range may not decrease effectiveness of method 500. In some examples, the first duration may be greater than or equal to 5 minutes.

At 506, method 500 includes flushing the rebalancing system with a third amount of water. Flushing the rebalancing system may proceed similarly to flushing the rebalancing system at 502. The inlet of the rebalancing system may be fluidly coupled to a water source and the water flowing from the outlet may be directed to waste. In some examples, the third amount of water may be deionized water or distilled water. In alternate examples, the third amount of water may be tap water. Further, the third amount water may be 50 L of water held at ambient and/or room temperature. In some examples, a temperature of the third amount of water may in a range of a freezing point to a boiling point of the third amount of water. In alternate examples, the temperature of the third amount of water may be in a range of room temperature to a boiling point of the third amount of water.

At 508, method 500 includes contacting a catalyst of the rebalancing system with citrate (e.g., trisodium citrate) solution for a second duration. Herein, all water soluble salts of the citrate anion or combinations of soluble salts of the citrate anion are considered for the citrate source of the citrate solution. By contacting the catalyst of the rebalancing system with the citrate solution, the citrate may disperse a diffusion double layer formed at a surface of the catalyst. By dispersing the diffusion double layer, the citrate solution may at least partially recover a reduction rate of the rebalancing system. In some examples, a temperature of the citrate solution may be in a range of a freezing point to a boiling point of the citrate solution. In alternate examples, the temperature of the citrate solution may be in range of room temperature to a boiling point of the citrate solution. In some examples, the dispersing of the diffusion double layer by the citrate solution may be enhanced when the citrate solution is a warm citrate solution. In some examples, the temperature of the warm citrate solution may be in a range of 60° C. to a boiling point of the citrate solution. A temperature of citrate solution may be warmed but below a temperature which may degrade components of the rebalancing system. In further examples, the citrate solution may be 60° C. or approximately 60° C. Additionally, the citrate solution may be a dilute citrate solution. In one embodiment, the concentration of citrate in the citrate solution may be in a range of 0.030 M to 2.3 M. As a further example the concentration of citrate in the citrate solution may be greater than or equal to 0.1 M and less than or equal to 1 M. As a further example, a concentration of citrate in the citrate solution may be 0.25 M. A length of the second duration may depend on a type of rebalancing system being recovered. The second duration may be longer for recovering a rebalancing cell than recovering a rebalancing reactor. As one example, if the rebalancing system is the rebalancing cell, the second duration may be 16 hours. As a further example, if the rebalancing system is the rebalancing reactor, the second duration may be 4 hours.

At 509, contacting the catalyst of the rebalancing system with citrate solution optionally includes circulating the citrate solution through the rebalancing system. Circulating the citrate solution may include fluidly coupling the outlet of rebalancing system to the inlet of rebalancing system, in a manner similar to circulating the pretreating water. In this way, warm citrate flows multiple times through the electrolyte passages of the rebalancing system. In some examples, the citrate solution may be held above ambient temperature by a heater. Further, the citrate solution may be held at 60° C. or approximately 60° C. during circulation. In further examples, the temperature of the citrate solution during circulation may be in a range of a freezing point to a boiling point of the citrate solution. In some examples, the temperature of the citrate solution during circulation may be in a range of room temperature to a boiling point of the citrate solution. Further, circulating the citrate solution may include circulating 100 L of citrate solution. Circulating the citrate solution may include circulating at a rate in a range of 1-60 liters per minute per m². As a further example, circulating the citrate solution may include circulate at a rate between 28 liters per minute (1 pm) and 301 pm.

At 510, contacting the catalyst of the rebalancing system with citrate solution optionally includes soaking the catalyst in citrate solution. As described above, a temperature of the citrate solution may be kept in range of a freezing point up to a boiling point of the citrate solution during soaking. Alternately the citrate solution may be kept in a range of room temperature up to a boiling point of the citrate solution during soaking. In some examples, soaking the catalyst may include removing the catalyst from the rebalancing system and performing soaking in a separate soaking system. In alternate examples, soaking the catalyst may include flooding the electrolyte passages of the rebalancing system with citrate solution and leaving the citrate solution in place without circulating for the second duration.

At 512, method 500 includes flushing the rebalancing system with a fourth amount of water. Flushing the rebalancing system with the fourth amount of water may be performed similarly to steps 502 and 506. The fourth amount of water may be similar to the first amount of water, second amount of water, and third amount of water. In some examples the first, second, third, and fourth amounts of water may be equivalent. The fourth amount of water may be deionized water, distilled water, or tap water and may be held at room temperature and/or ambient temperature or in a range of a freezing point up to a boiling point of the fourth amount of water. In some examples, the fourth amount of water may be held at temperature in a range of room temperature up to the boiling point of the fourth amount of water. Further, in some examples, the fourth amount of water may be 50 L. The flushing water may be water which has not previously passed through electrolyte passages of the rebalancing system. In this way, the flushing water removes any residual citrate ions or associated cations from the rebalancing system and the system may thereafter be ready for reintroduction of electrolyte.

At 513, method 500 includes contacting the catalyst of the rebalancing system with a readily oxidizable gas a third duration. As one example, the readily oxidizable gas may be hydrogen gas. By contacting the catalyst of the rebalancing system with the oxidizable gas, the precious metal particles comprising the catalyst active sites of the catalyst may be electrochemically reduced. By electrochemically reducing the precious metal particles, the oxidizable gas may at least partially recover a reduction rate of the rebalancing system. In an example where the rebalancing system is a rebalancing reactor, the gas may be entrained in a two-phase flow with a process liquid. In an example where the rebalancing system is a rebalancing cell, the gas may flow through the hydrogen channels, hydrogen passages, and/or flow field. In one example, the gas may be recirculated through the rebalancing system. In an alternate example, gas may flow through the rebalancing system with replenishment from an external source. In some examples, step 513 may be performed in concert with steps 508 or 512. In alternate examples, it may be performed independently of catalyst contact with a citric acid solution, pretreating water, and/or flushing water. For example, step 513 may be performed independently of steps 501, 508, and 512. For example, step 513 may be performed before and/or after any of steps 501, 508, and 512. A length of the third duration may depend on a type of rebalancing system being recovered and/or the process step done in concert with the contact of oxidizable gas. The third duration may be longer for recovering a rebalancing cell than recovering a rebalancing reactor. The third duration may be shorter if done in concert with step 512 and longer if done in concert with step 508. As one example, the third duration may be equal to the length of the second duration. Method 500 ends.

Method 500 may be performed in response to degradation of performance of a rebalancing system over time. An example of a decrease in performance observed for a rebalancing system, at least partially due to formation of a diffusion double layer of the catalyst is shown in graph 600 of FIG. 6. Graph 600 shows reduction rate of a rebalancing cell as a function of state of charge (SOC) of the electrolyte passing though the cell. Arrow 602 corresponds to a direction of increasing reduction rate along the y-axis and arrow 604 corresponds to a direction of increasing SOC along the x-axis. The rebalancing system measured in graph 600 is a rebalancing cell including five electrode cells.

A line 606 corresponds to an average reduction rate as a function of state of charge for the rebalancing cell. The average rate may be slightly below an initial reduction rate of the rebalancing reaction as observed when first installed, and indicated on graph 600 by the data points within dashed circle 608. The rebalancing cell was operated for a cumulative total of 56 days (approx. 1300 hrs. of operation). After operation for 56 days, the reduction rate of the rebalancing cell was measured and shown on graph 600 as data points 610. A lower than the average reduction rate as shown after 56 days as indicated by data points 610. After 56 days, the performance of the rebalancing cell is degraded and the reduction rate is well below the average reduction rate. The rebalancing cell was also tested after 56 days coupled to a different redox battery system and shown on graph 600 as data points 612. Even in a different redox flow battery system tested at a different SOC, the reduction rate of the rebalancing cell is significantly below an average reduction rate of the rebalancing cell.

A rebalancing cell with degraded performance, as shown by data points 610 and 612 of FIG. 6 may be subjected to procedures to recover activity of a catalyst of the rebalancing cell and thereby increase a reduction of rate of the rebalancing cell. A series of recovery procedures were performed sequentially on a degraded rebalancing cell including 5 electrode cells. The recovery procedures include flushing and circulating steps which may be performed similarly to the steps described above with respect to method 500. Further, the solutions described below with respect to the recovery procedures may be at room temperature and/or ambient temperature if not otherwise noted.

Turning now to FIG. 7, an outcome of each recovery procedure is shown in graph 700. A y-axis on the left side of graph 700 corresponds to an average reduction rate over one hour normalized by SOC. Arrow 701 corresponds to a direction of increasing normalized reduction rate along the left y-axis. A y-axis on the right side of graph 700 corresponds to a percentage of performance recovered when compared to an initial performance of the rebalancing cell. Arrow 703 corresponds to a direction of increasing recovered performance.

Column 702 corresponds to the results after a first recovery procedure. The first recovery procedure includes flushing the rebalancing cell with deionized water followed by flushing with a room temperature 0.25 M sodium citrate solution, followed by a second flush with deionized water. Column 704 corresponds to the second recovery procedure. The second recovery procedure includes flushing the rebalancing cell with deionized (DI) water followed by circulating a fresh amount of DI water. The circulating DI water is replaced half-way through the circulation duration. After circulating DI water, a room temperature solution of 0.25 M sodium citrate is circulated through the rebalancing cell followed circulating DI water again. As shown in graph 700, a slight recovery of rebalancing cell performance is seen after the first procedure, but little if any additional recovery of rebalancing cell performance is observed following the second procedure.

Column 706 corresponds to the results after a third recovery procedure. The third recovery procedure includes flushing the rebalancing cell with DI water followed by circulating a dilute, 1M solution of hydrochloric acid warmed to 60° C. throughout the rebalancing cell followed by a flush with DI water. After the DI water flush, a dilute aqueous 0.25 M solution of sodium citrate held at 60° C. was circulated throughout the rebalancing cell followed by a flush with DI water. After the DI water flush, the rebalancing cell is drained of fluid and allowed to dry while exposed to atmospheric air followed by circulating DI water through the rebalancing cell. The third procedure also results in some recovery of the rebalancing rate of the rebalancing cell.

Column 708 corresponds to the results of a fourth recovery procedure. The fourth recovery procedure includes flushing the rebalancing cell with DI water followed by circulating fresh DI water throughout the rebalancing cell. After, electrolyte outlets and a hydrogen inlet of the rebalancing cell are capped and the rebalancing cell filled with fresh DI water. A thermocouple is placed in direct thermal contact with the water filling the rebalancing cell and communicatively coupled to an oven. The oven is operated to maintain the water inside the rebalancing cell at 80° C. for a duration of time. After the duration is finished, the water is drained from the cell and replaced with fresh water and the heating procedure repeated for a total of three thermal cycles. Finally, the rebalancing cell is flushed with fresh DI water. As shown in graph 700, after the fourth recovery procedure, the reduction rate of the rebalancing cell is less than it was after the third procedure.

Column 710 corresponds to the results of a fifth recovery procedure. The fifth recovery procedure includes flushing the rebalancing cell with DI water followed by circulating fresh DI water throughout the rebalancing cell. After, 0.25 M sodium citrate solution held at 60° C. is circulated throughout the rebalancing cell at a rate of about 1.25 lpm followed by a final flush with DI water. As shown in graph 700, after the fifth recovery procedure, the reduction rate increases significantly and approaches 50% of the initial reduction rate observed for the rebalancing cell.

Colum 712 corresponds to the results of the sixth recovery procedure. The sixth recovery procedure is similar to the fifth recovery procedure and includes flushing the rebalancing cell with DI water followed by circulating fresh DI water throughout the rebalancing cell. After, 0.25 M sodium citrate solution held at 60° C. is circulated throughout the rebalancing reactor at a rate of about 8.5 lpm followed by a final flush with DI water. As shown in graph 700, the sixth procedure also results in an increase in reduction rate of the rebalancing cell. After the sixth procedure, the rebalancing has reached just over 70% of the initial cell performance.

Because the first through sixth recovery procedures were performed on the same rebalancing cell sequentially it may be informative to graph percent change over previous tests for each recovery procedure as shown in graph 800 of FIG. 8. A y-axis of graph 800 corresponds to a percent improvement, as measured by average normalized reduction rate, over previous tests (e.g., previous procedures) is shown. Arrow 801 corresponds to a direction of increasing percent improvement along the y-axis. Column 802 corresponds to after the first procedure, column 804 corresponds to after the second procedure, column 806 corresponds to after the third procedure, column 808 corresponds to after the fourth procedure, column 810 corresponds to after the fifth procedure and column 812 corresponds to after the sixth procedure.

In this representation, it is shown that the biggest increase in reduction rate was seen after the third procedure, which is the procedure wherein warm (e.g., 60° C.) sodium citrate solution was first introduced. Additionally, further increase in reduction rate was observed upon further circulation of warm sodium citrate solution throughout the rebalancing cell in the fifth and sixth procedures. A rebalancing method 500 of FIG. 5 may include features of the first through sixth recovery procedures for which a significant increase in rebalancing cell reduction rate is observed.

The rebalancing cell that was recovered as described above with respect to FIGS. 6-8 includes 5 electrode cells. However, a number of electrode cells of a rebalancing cell may be increased to scale with an output of the redox flow battery system. For example, a large rebalancing cell may include at least 30 electrode cells. Turning now to FIG. 9, a graph 900 of normalized reduction rate for a first rebalancing cell a second rebalancing cell, and a third rebalancing cell is shown. An arrow 901 corresponds to a direction of increasing normalized reduction rate along a y-axis of graph 900.

A first column 902 of graph 900 corresponds to a normalized average reduction rate of a five electrode cell. A second column 904 corresponds to an initial normalized average reduction rate of a first 30-cell rebalancing cell and a third column 908 corresponds to an initial average reduction rate of a second 30-cell rebalancing cell. As is seen in graph 900, a normalized reduction rate may vary for each rebalancing cell, even if a number of electrode cells in the rebalancing cell is the same.

A fourth column 906 corresponds to a normalized reduction rate for the first 30-cell rebalancing cell after a catalyst recovery method, such as method 500 of FIG. 5., is performed on the rebalancing cell. Even when the rebalancing cell is scaled up from 5 electrode cells to 30 electrode cells, the recovery method including circulating warm sodium citrate solution still results in an increase in normalized reduction rate.

In addition to rebalancing cells, a rebalancing system of a redox flow battery system may additionally or alternatively include a rebalancing reactor such as a rebalancing reactor including a jelly roll catalyst as shown in FIG. 4. Turning now to FIG. 10, a graph 1000 of ferric reduction rate for rebalancing reactors is shown. An arrow 1001 corresponds to a direction of increasing reduction rate along the y-axis. A first data set 1002 corresponds to a first rebalancing reactor, a second data set 1004 corresponds to a second rebalancing reactor, a third data set 1006 corresponds to a third rebalancing reactor, a fourth data set 1008 corresponds to a fourth rebalancing reactor.

An initial reduction rate was recorded for each rebalancing reactor and is shown by columns 1002a, 1004a, 1006a, and 1008a for the first through fourth rebalancing reactors respectively. The initial performance of each rebalancing reactor was substantially the same. Each rebalancing reactor was subject to about 900 hours of use and a subsequent degraded reduction rate was measured for each. Columns 1002b, 1004b, 1006b, and 1008b correspond to the degraded reduction rates of the first through fourth rebalancing reactors respectively.

Each rebalancing reactor was then subject to a recovery procedure. Each reactor may be subjected to a pretreatment wash prior to the recovery procedure. The pretreatment wash may include removing the catalyst roll (e.g., catalyst bed 400) from the outer housing and soaking the catalyst roll in DI water until a pH of the water is neutral after 24 hours. A catalyst roll of the first rebalancing reactor was soaked in a stirred 0.25 M sodium citrate solution held at 20° C. for 16 hours. The recovered reduction rate of the first rebalancing reactor is shown by column 1002c. A catalyst roll of the second rebalancing reactor was soaked in a stirred 0.25 M sodium citrate solution held at 20° C. for 8 hours. The recovered reduction rate of the second rebalancing reactor is shown by column 1004c. Comparing recovery of the first rebalancing reactor to the second rebalancing reactor, soaking the catalyst roll for a longer time does not result in increased recovery. A catalyst roll of the third rebalancing reactor was soaked in a stirred 0.25 M sodium citrate solution held at 20° C. for 2 hours. A recovered reduction rate of the third rebalancing reactor is shown by column 1006c. The catalyst roll of the third rebalancing reactor was further soaked in a stirred 0.25 M sodium citrate solution held at 60° C. for four hours. A recovered reduction rate of the third rebalancing reactor after the additional warm sodium citrate soak is shown by column 1006d. Soaking in the warm sodium citrate solution resulted in additional recovered reduction rate, almost to the initial recovered reduction rate. A catalyst roll of the fourth rebalancing reactor was soaked in a stirred 0.25 M sodium citrate solution held at 20° C. for four hours. A recovered reduction rate of the fourth rebalancing reactor is shown by column 1008c. Comparing column 1008b to column 1004c, soaking for four hours resulted in a similar recovery to soaking for 8 hours. In this way, the contacting the catalyst with sodium citrate solution is shown to result in significant recovery in reduction rate for rebalancing reactors, similar to the recovery observed for rebalancing cells.

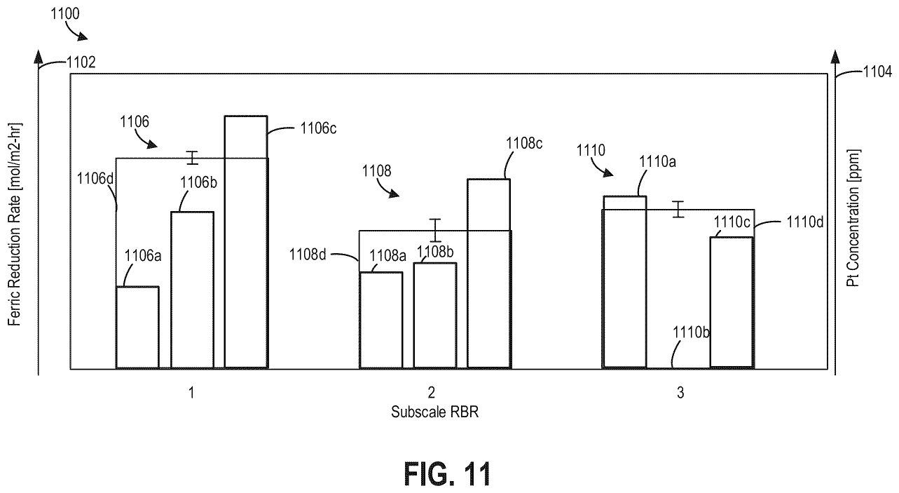

Turning now to FIG. 11, a graph 1100 showing ferric reduction rate on a left y-axis and measured platinum concentration on a right y-axis for three different rebalancing reactors. An arrow 1102 shows a direction of increasing reduction rate along the left y-axis and an arrow 1104 shows a direction of increasing platinum concentration along the right y-axis. A first data set 1106 corresponds to a first rebalancing reactor, a second data set 1108 corresponds to a second rebalancing reactor and third data set 1110 corresponds to a third rebalancing reactor. Columns 1106a, 1108a, and 1110a each correspond to a measured degraded performance of each for the first through third rebalancing reactors respectively. The degraded performance is measured immediately prior to performing a recovery procedure.

Each of the first, second, and third rebalancing reactors was subject to the same recovery procedure. First, DI water is circulated through the rebalancing reactor (e.g., an outlet of the rebalancing reactor is fluidly coupled to an inlet of the rebalancing reactor) for a duration. Halfway through the duration, the DI water may be replaced with fresh DI water. The catalyst roll is then removed from the outer housing and soaked first in stirred 20° C. 0.25 M sodium citrate solution for two hours and then soaked in a stirred 60° C. 0.25 M sodium citrate for four hours. Columns 1106b, 1108b, and 1110b each correspond to a measured ferric reduction rate after the 20° C. sodium citrate soak for the first through third rebalancing reactors respectively. Columns 1106c, 1108c, and 1110c each correspond to a measured ferric reduction rate after the 60° C. sodium citrate soak for the first through third rebalancing reactors respectively. Each of the first, second, and third rebalancing reactors demonstrated increased reduction rate after further soaking in warm sodium citrate solution as compared to soaking in the room temperature sodium citrate solution.

Columns 1106d, 1108d, and 1110d each correspond to a platinum concentration of the first, second, and third rebalancing reactors respectively. If platinum is still present in the rebalancing reactor, performance of the rebalancing reactor may be at least partially recovered. Measuring a platinum concentration of rebalancing reactor may indicate a potential for performance of the rebalancing reactor to be recovered if additional or further steps are demanded for reactor recovery. Said another way, if platinum concentration is lower than a threshold amount, additional platinum may be added to rebalancing reactor instead of or in addition to performing a recovery procedure.

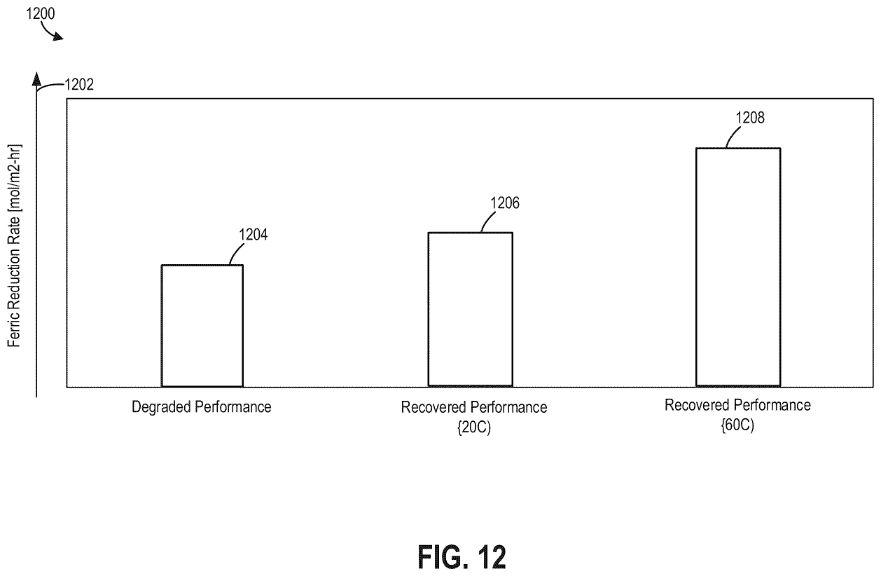

The first through fourth rebalancing reactors of FIG. 10 and the first through third rebalancing reactors of FIG. 11 may each be small scale rebalancing reactors. Turning now to FIG. 12, a graph 1200 shows pre and post recovered performance of a large scale rebalancing reactor as shown by ferric reduction rate. An arrow 1202 corresponds to a direction of increasing ferric reduction rate along the y-axis. A surface area of a catalyst roll of the small scale rebalancing reactor may be smaller than a surface area of a catalyst roll of a large scale rebalancing reactor. As one example, a small rebalancing reactor may have 2% the catalyst surface area (geometric) of a large rebalancing reactor.

A first column 1204 corresponds to a degraded reduction rate of the rebalancing reactor as measured immediately prior to performing a recovery procedure. The recovery procedure for the large scale rebalancing reactor is similar to method 500 described above. Catalyst roll soaking steps may be replaced with circulation of solution throughout the rebalancing reactor. The recovery procedure of the large scale rebalancing reactor includes flushing with DI water followed by circulating DI water through the rebalancing reactor followed by another DI water flush, all at room temperature/ambient temperature. Next a 20° C. 0.25 M sodium citrate solution was circulated through the rebalancing reactor followed by a last flush with DI water. An amount of water and citrate solution may be scaled relative to the surface area of the catalyst roll included in the rebalancing reactor. A reduction rate of the large scale rebalancing reactor following 20° C. sodium citrate treatment is shown by second column 1206. Some increase in reduction rate over the original, degraded rebalancing reactor is seen after room temperature sodium citrate treatment.

The rebalancing reactor was further recovered by circulating a 0.25 M sodium citrate throughout the rebalancing reactor at 60° C. followed by flushing with DI water. Third column 1208 corresponds to the rebalancing rate after the 60° C. sodium citrate treatment. Further treatment with the 60° C. sodium citrate further recovered the reduction rate of the rebalancing reactor, past what was measured for the room temperature treatment alone.

Turning now to FIG. 13, a graph 1300 compares a percent change (e.g., percent increase) reduction rate after recovery measured for small and large scale rebalancing reactors treated with comparative recovery procedures. An arrow 1301 corresponds to a direction of increasing percent change along a y-axis of graph 1300. A first column 1302 corresponds to the percent change in reduction rate measured for the second rebalancing reactor of FIG. 11. A second column 1304 corresponds to the change in reduction rate measured for the first rebalancing reactor of FIG. 11. A third column 1306 corresponds to the change in reduction rate measured for the large scale rebalancing reactor of FIG. 12. As shown in graph 1300, a percent change in rebalancing reactor reduction rate is similar for small and large scale rebalancing reactors. In this way, the rebalancing reactor recovery procedure is shown to be scalable for different sized rebalancing reactors.

The technical effect of method 500 is to increase a degraded reduction rate of a rebalancing system of a redox flow battery system. The method may be easily adapted to a desired size and type of rebalancing system. Further the method may use mild temperatures and common reagents. Recovery of the rebalancing reactor following the method of 500 may help disperse a diffusion double layer and regenerate a useful surface of a catalyst of the rebalancing system. In this way, the expense of replacing the catalyst, especially a rare metal catalyst, may be avoided.

The disclosure also provides support for a method for recovering a rebalancing system, comprising: contacting a catalyst of the rebalancing system with a citrate solution, wherein the citrate solution disperses a diffusion double layer from a surface of the catalyst. In a first example of the method, contacting the catalyst of the rebalancing system with the citrate solution includes circulating the citrate solution through the rebalancing system or soaking the catalyst in the citrate solution. In a second example of the method, optionally including the first example, contacting the catalyst of the rebalancing system with the citrate solution includes circulating the citrate solution through the rebalancing system at a rate in a range of 1-60 L/min-m2. In a third example of the method, optionally including one or both of the first and second examples, a concentration of citrate in the citrate solution is in a range of 0.030 M to 2.3 M. In a fourth example of the method, optionally including one or more or each of the first through third examples, a temperature of the citrate solution is in a range of a freezing point of the citrate solution to a boiling point of the citrate solution. In a fifth example of the method, optionally including one or more or each of the first through fourth examples, the method further comprises: contacting the catalyst of the rebalancing system with a readily oxidizable gas for a duration, wherein the readily oxidizable gas electrochemically reduces precious metal particles comprising catalyst active sites of the catalyst, in concert with or independent of the contacting the catalyst of the rebalancing system with the citrate solution. In a sixth example of the method, optionally including one or more or each of the first through fifth examples, the method further comprises: pretreating the rebalancing system with pretreating water before contacting the catalyst of the rebalancing system with the citrate solution, and wherein the pretreating water is deionized water, distilled water or tap water. In a seventh example of the method, optionally including one or more or each of the first through sixth examples, a temperature of the pretreating water is in a range a freezing point to a boiling point of the pretreating water. In a eighth example of the method, optionally including one or more or each of the first through seventh examples, the method further comprises: flushing the rebalancing system with flushing water after contacting the catalyst of the rebalancing system with the citrate solution, and wherein the flushing water is deionized water, distilled water, or tap water. In a ninth example of the method, optionally including one or more or each of the first through eighth examples, a temperature of the flushing water is in a range of a freezing point to a boiling point of the flushing water.

The disclosure also provides support for a method for recovering a rebalancing system, comprising: pretreating the rebalancing system with pretreating water, circulating a citrate solution throughout electrolyte passages of the rebalancing system for a first duration, and after circulating the citrate solution for the duration, flushing the rebalancing system with flushing water, wherein the flushing water has not previously passed through the rebalancing system, and in concert with or independent of circulating the citrate solution or flushing water, flowing a readily oxidizable gas through hydrogen passages of the rebalancing system for a second duration. In a first example of the method, pretreating the rebalancing system with pretreating water includes, sequentially, flushing the rebalancing system with a first amount of water, circulating a second amount of water throughout the rebalancing system, and flushing the rebalancing system with a third amount of water. In a second example of the method, optionally including the first example, a temperature of the citrate solution is in a range of a freezing point of the citrate solution to a boiling point of the citrate solution. In a third example of the method, optionally including one or both of the first and second examples, a concentration of citrate in the citrate solution is in a range of 0.030 M to 2. 3M. In a fourth example of the method, optionally including one or more or each of the first through third examples, the pretreating water and the flushing water are deionized water, distilled water, or tap water. In a fifth example of the method, optionally including one or more or each of the first through fourth examples, circulating the citrate solution includes circulating at a rate in a range of 1-60 L/min-m2. In a sixth example of the method, optionally including one or more or each of the first through fifth examples, a temperature of the pretreating water and flushing water is in a range of a freezing point to a boiling point of the pretreating and flushing water.

The disclosure also provides support for a method for recovering a rebalancing comprising: contacting a catalyst of the rebalancing system with a readily oxidizable gas for a duration, wherein the oxidizable gas electrochemically reduces precious metal particles comprising catalyst active sites of the catalyst. In a first example of the method, contacting the catalyst of the rebalancing system with the oxidizable gas for a duration is performed in concert with or independent of catalyst contact with citrate solution or flushing water. In a second example of the method, optionally including the first example, the oxidizable gas may be recirculated through the rebalancing system and/or the gas may flow through the rebalancing system with replenishment from an external source.

In an alternate embodiment, the disclosure also provides support for a method for recovering a rebalancing system, comprising: contacting a catalyst of the rebalancing system with a citrate solution, wherein the citrate solution disperses a diffusion double layer from a surface of the catalyst. In a first example of the method, contacting the catalyst of the rebalancing system with the citrate solution includes circulating the citrate solution through the rebalancing system or soaking the catalyst in the citrate solution. In a second example of the method, optionally including the first example, contacting the catalyst of the rebalancing system with the citrate solution includes circulating the citrate solution through the rebalancing system at a rate in a range of 1-60 L/min-m2. In a third example of the method, optionally including one or both of the first and second examples, a concentration of citrate in the citrate solution is in a range of 0.030 M to 2.3 M. In a fourth example of the method, optionally including one or more or each of the first through third examples, a temperature of the citrate solution is in a range of a freezing point to a boiling point of the citrate solution. In a fifth example of the method, optionally including one or more or each of the first through fourth examples, the method further comprises: pretreating the rebalancing system with pretreating water before contacting the catalyst of the rebalancing system with the citrate solution, and wherein the pretreating water is distilled water or tap water. In a sixth example of the method, optionally including one or more or each of the first through fifth examples, a temperature of the pretreating water is in a range of a freezing point to a boiling point of the pretreating water. In a seventh example of the method, optionally including one or more or each of the first through sixth examples, the method further comprises: flushing the rebalancing system with flushing water after contacting the catalyst of the rebalancing system with the citrate solution, and wherein the flushing water is distilled or tap water. In an eighth example of the method, optionally including one or more or each of the first through seventh examples, a temperature of the flushing water is in a range of a freezing point to a boiling point of the flushing water.

In an alternate embodiment, the disclosure also provides support for a method for recovering a rebalancing system, comprising: pretreating the rebalancing system with pretreating water, circulating a citrate solution throughout electrolyte passages of the rebalancing system for a duration, and after circulating the citrate solution for the duration, flushing the rebalancing system with flushing water, wherein the flushing water has not previously passed through the rebalancing system. In a first example of the method, pretreating the rebalancing system with pretreating water includes, sequentially, flushing the rebalancing system with a first amount of water, circulating a second amount of water throughout the rebalancing system, and flushing the rebalancing system with a third amount of water. In a second example of the method, optionally including the first example, the citrate solution is 60° C. In a third example of the method, optionally including one or both of the first and second examples, a concentration of citrate in the citrate solution is no less than 0.1 M and no greater than 1 M. In a fourth example of the method, optionally including one or more or each of the first through third examples, the duration is longer when the rebalancing system is a rebalancing cell than when the rebalancing system is a rebalancing reactor. In a fifth example of the method, optionally including one or more or each of the first through fourth examples, the pretreating water and the flushing water are deionized water. In a sixth example of the method, optionally including one or more or each of the first through fifth examples, circulating the citrate solution includes circulating at a rate in a range of 28 liters per minute to 30 liters per minute. In a seventh example of the method, optionally including one or more or each of the first through sixth examples, the pretreating water and flushing water are at room temperature.

In an alternate embodiment, the disclosure also provides support for a redox flow battery system, comprising, an electrode compartment, a rebalancing system fluidly coupled to the electrode compartment, an electrolyte storage tank fluidly coupled to the rebalancing system and the electrode compartment, wherein electrolyte is configured to flow from the electrode compartment to the rebalancing system and from the rebalancing system to the electrolyte storage tank, and a controller including instructions stored in non-transitory memory, the instructions executable by the controller to: determine a reduction rate of the rebalancing system, and in response to the reduction rate of the rebalancing system below a threshold reduction rate, indicating a request for rebalancing system recovery by contacting a catalyst of the rebalancing system with a citrate solution. In a first example of the system, the rebalancing system is a rebalancing reactor configured to receive electrolyte suffused with hydrogen gas, and wherein electrolyte reacts with hydrogen gas at a surface of a catalyst roll, and wherein a surface area of the catalyst roll of the rebalancing reactor is at least 1 m². In a second example of the system, optionally including the first example, the rebalancing system is rebalancing cell configured to receive hydrogen through a hydrogen inlet and electrolyte through an electrolyte inlet, wherein the electrolyte reacts with the hydrogen in an electrode cell.

In an alternate embodiment, the disclosure provides support for a redox flow battery system, comprising, an electrode compartment, a rebalancing system fluidly coupled to the electrode compartment, an electrolyte storage tank fluidly coupled to the rebalancing system and the electrode compartment, wherein electrolyte is configured to flow from the electrode compartment to the rebalancing system and from the rebalancing system to the electrolyte storage tank, and a controller including instructions stored in non-transitory memory, the instructions executable by the controller to: determine a reduction rate of the rebalancing system, and in response to the reduction rate of the rebalancing system below a threshold reduction rate, indicating a request for rebalancing system recovery by contacting a catalyst of the rebalancing system with a citrate solution. In a first example of the system, the catalyst is precious metal. In a second example of the system, optionally first example, the reduction rate is a rate of Fe³⁺ reduction to Fe²⁺ .

In an alternate embodiment, the disclosure also provides support for a method of recovering a rebalancing system, comprising: flushing the rebalancing system with a first amount of water, circulating a second amount of water throughout the rebalancing system, flushing the rebalancing system with a third amount of water, circulating a citrate solution throughout the rebalancing system, and flushing the rebalancing system with a fourth amount of water. In a first example of the method, the first, second, third, and fourth amounts of water are equivalent. In a second example of the method, optionally including the first example, the rebalancing system includes a catalyst and circulating the citrate solution disperses a diffusion double layer formed on a surface of the catalyst. In a third example of the method, optionally including one or both of the first and second examples, a reduction rate of the rebalancing system increases after the method is performed. In a fourth example of the method, optionally including one or more or each of the first through third examples, the first amount of water flushes acidic electrolyte from the rebalancing system.

FIGS. 2-3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 2-3 are drawn approximately to scale, although other dimensions or relative dimensions may be used.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for recovering a rebalancing system, comprising:
contacting a catalyst of the rebalancing system with a citrate solution, wherein the citrate solution disperses a diffusion double layer from a surface of the catalyst.

2. The method of claim 1, wherein contacting the catalyst of the rebalancing system with the citrate solution includes circulating the citrate solution through the rebalancing system or soaking the catalyst in the citrate solution.

3. The method of claim 1, wherein contacting the catalyst of the rebalancing system with the citrate solution includes circulating the citrate solution through the rebalancing system at a rate in a range of 1-60 L/min-m².

4. The method of claim 1, wherein a concentration of citrate in the citrate solution is in a range of 0.030 M to 2.3 M.

5. The method of claim 1, wherein a temperature of the citrate solution is in a range of a freezing point of the citrate solution to a boiling point of the citrate solution.

6. The method of claim 1, further comprising contacting the catalyst of the rebalancing system with a readily oxidizable gas for a duration, wherein the readily oxidizable gas electrochemically reduces precious metal particles comprising catalyst active sites of the catalyst, in concert with or independent of the contacting the catalyst of the rebalancing system with the citrate solution.

7. The method of claim 1, further comprising pretreating the rebalancing system with pretreating water before contacting the catalyst of the rebalancing system with the citrate solution, and wherein the pretreating water is deionized water, distilled water or tap water.

8. The method of claim 7, wherein a temperature of the pretreating water is in a range a freezing point to a boiling point of the pretreating water.

9. The method of claim 1, further comprising flushing the rebalancing system with flushing water after contacting the catalyst of the rebalancing system with the citrate solution, and wherein the flushing water is deionized water, distilled water, or tap water.

10. The method of claim 9, wherein a temperature of the flushing water is in a range of a freezing point to a boiling point of the flushing water.

11. A method for recovering a rebalancing system, comprising:
pretreating the rebalancing system with pretreating water;
circulating a citrate solution throughout electrolyte passages of the rebalancing system for a first duration;
after circulating the citrate solution for the duration, flushing the rebalancing system with flushing water, wherein the flushing water has not previously passed through the rebalancing system; and
in concert with or independent of circulating the citrate solution or flushing water, flowing a readily oxidizable gas through hydrogen passages of the rebalancing system for a second duration.

12. The method of claim 11, wherein pretreating the rebalancing system with pretreating water includes, sequentially, flushing the rebalancing system with a first amount of water, circulating a second amount of water throughout the rebalancing system, and flushing the rebalancing system with a third amount of water.

13. The method of claim 11, wherein a temperature of the citrate solution is in a range of a freezing point of the citrate solution to a boiling point of the citrate solution.

14. The method of claim 11, wherein a concentration of citrate in the citrate solution is in a range of 0.030 M to 2.3 M.

15. The method of claim 11, wherein the pretreating water and the flushing water are deionized water, distilled water, or tap water.

16. The method of claim 11, wherein circulating the citrate solution includes circulating at a rate in a range of 1-60 L/min-m².

17. The method of claim 11, wherein a temperature of the pretreating water and flushing water is in a range of a freezing point to a boiling point of the pretreating water and the flushing water.

18. A method for recovering a rebalancing system, comprising:
contacting a catalyst of the rebalancing system with a readily oxidizable gas for a duration, wherein the readily oxidizable gas electrochemically reduces precious metal particles comprising catalyst active sites of the catalyst.

19. The method of claim 18, wherein contacting the catalyst of the rebalancing system with the readily oxidizable gas for a duration is performed in concert with or independent of catalyst contact with citrate solution or flushing water.

20. The method of claim 18, wherein the readily oxidizable gas may be recirculated through the rebalancing system and/or the gas may flow through the rebalancing system with replenishment from an external source.
